(19) United States
(12) Patent Application Publication
(10) Pub. No.: US 2024/0353885 A1
(43) Pub. Date: Oct. 24, 2024

(54) CYPHER SYSTEM, CYPHER APPARATUS, CYPHER METHOD, AND PROGRAM

(71) Applicant: NIPPON TELEGRAPH AND TELEPHONE CORPORATION, Tokyo (JP)

(72) Inventors: Junko TAKAHASHI, Tokyo (JP); Koji CHIDA, Tokyo (JP); Shota KITA, Tokyo (JP); Akihiko SHINYA, Tokyo (JP)

(21) Appl. No.: 18/294,329

(22) PCT Filed: Sep. 1, 2021
(86) PCT No.: PCT/JP2021/032193

§ 371 Date: Feb. 1, 2024

(51) Int. Cl. G06E 1/04; H04L 9/10

(52) U.S. Cl. CPC G06E 1/04; H04L 9/10

(57) ABSTRACT

A cypher system includes a plurality of hardware computers, each hardware computer including a photoelectric fusion processor that includes at least one of (i) a Y gate circuit configured to combine optical signals, (ii) an optical switching circuit configured to switch optical signal paths based on electrical signals, or (iii) a phase modulator configured to modulate a phase of an optical signal. The photoelectric fusion processor is configured to perform optical operation processing and perform an encryption operation including an exclusive OR operation in which two or more bit values are given as inputs, and a nonlinear operation in which two or more bit values are given as inputs.

### TECHNICAL FIELD

The present invention relates to a cypher system, a cypher apparatus, a cypher method, and a program.

### BACKGROUND ART

In recent years, research and development for realizing an all-photonics network have been conducted. The all-photonics network aims at transmission with low power consumption, a high quality, a large capacity, and low latency, by applying optical technologies to all parts such as a network and a terminal. As for applying the technologies, on the assumption that the optical technology applies to the inside of the terminal, photoelectric fusion processors are also researched and developed. In such research and development, ψ gates and optical pass gate logic circuits, which are optical operation gates capable of performing logical operations in the form of optical signals, have been proposed. For example, Non-Patent Literature 1 proposes a ψ gate that allows for an optional logical operation, in which when a logical operation between optical signals of two input lights corresponding to two bits is performed, three input lights are obtained based on a concept of bias light, thereby changing intensity of the bias light or a phase difference between the bias light and the two input lights.

It is known that, in a case where a single-wavelength multiplexing scheme using two wavelengths is used, the ψ gate allows for multistage connection of 128 (=2⁷) bit input and 1 bit output (1 bit output representing a result of a logical operation for 128 bits) by a logic gate having up to seven stages for four types of linearly separable logical operations: AND, NAND, OR, and NOR. In principle, a wavelength multiplexing scheme allows for doubling the number of input bits in accordance with the number of wavelength channels. On the other hand, for two types of linearly inseparable operations associated with an exclusive OR operation (XOR operation) and an XNOR operation, it is difficult to achieve the multistage connection only with the state of an optical signal as long as only optical interference is used, and only an operation for one bit (2-bit input and 1-bit output) can be performed. In addition, it is also difficult to perform a multistage operation including different logical operations such as an AND operation and an XOR operation.

### CITATION LIST

### Non-Patent Literature

Non Patent Literature 1: Nikkei Electronics, May 2020, NTT ga hikari dake de ronrienzan—denki no 300-bai tei-chien ni—(in Japanese) (NTT achieves logical operation only with light—300 times lower delay than electricity-)

### SUMMARY OF INVENTION

### Technical Problem

Meanwhile, in a case where the optical technology is implemented in a device such as a terminal, in order to secure operations by the terminal and optical communication, there is need for an encryption technology (encryption method and authentication method) for performing an encryption operation using optical bit information, performing authentication of a device, detecting falsification of data, and the like. In addition, an encryption operation in an existing encryption technology is performed by using a multistage operation of XORs or a multistage operation including different logical operations such as an AND operation and an XOR operation.

On the other hand, as described above, in optical operation processing, it is difficult to implement the multistage operation including XOR operations, and it is also difficult to implement the multistage operation including the different logical operations such as an XOR operation and an AND operation. It is therefore difficult to implement an encryption operation by the optical operation processing.

An embodiment of the present invention has been made in view of the above points, and an object of the embodiment is to implement an encryption operation by optical operation processing.

### Solution to Problem

In order to achieve the above object, in an encryption system according to an embodiment, a photoelectric fusion processor includes at least one of a Y gate circuit that superimposes optical signals on each other, an optical switching circuit that controls a path of an optical signal by an electrical signal, or a phase modulator that modulates a phase of an optical signal, and the photoelectric fusion processor executes, by using optical operation processing, an encryption operation including an exclusive OR operation of two or more bit values and a nonlinear operation of two or more bit values.

### Advantageous Effects of Invention

The encryption operation can be implemented by the optical operation processing.

### BRIEF DESCRIPTION OF DRAWINGS

FIG. 1 is a diagram illustrating a configuration example of an encryption device according to the present embodiment.

FIG. 2 is a diagram for illustrating an example of a 2-bit XOR operation using a Y gate circuit.

FIG. 3 is a diagram for illustrating an example of a 2-bit XOR operation using an MZI circuit (part 1).

FIG. 4 is a diagram for illustrating an operation example of an MZI circuit (part 1).

FIG. 5 is a diagram for illustrating an example of a 2-bit XOR operation using an MZI circuit (part 2).

FIG. 6 is a diagram for illustrating an operation example of an MZI circuit (part 2).

FIG. 7 is a diagram for illustrating an implementation example of AddRoundKey.

FIG. 8 is a diagram for illustrating an implementation example of the least significant one bit of SubBytes.

FIG. 9 is a diagram for illustrating an implementation example of SubBytes.

FIG. 10 is a diagram for illustrating an implementation example of SubBytes in which optical pass gate logic circuits are parallelized.

FIG. 11 is a diagram for illustrating an implementation example of ShiftRows.

FIG. 12 is a diagram for illustrating a calculation example of MixColumns.

FIG. 13 is a diagram for illustrating an example of a 6-bit XOR operation using a Y gate circuit.

FIG. 14 is a diagram for illustrating an example of an 8-bit XOR operation using a Y gate circuit.

FIG. 15 is a diagram for illustrating an example of a 6-bit XOR operation using phase modulators (part 1).

FIG. 16 is a diagram for illustrating an example of a 6-bit XOR operation using phase modulators (part 2).

FIG. 17 is a diagram for illustrating an example of an 8-bit XOR operation using phase modulators (part 1).

FIG. 18 is a diagram for illustrating an example of an 8-bit XOR operation using phase modulators (part 2).

FIG. 19 is a diagram for illustrating an example of a 6-bit XOR operation using phase modulators (part 3).

FIG. 20 is a diagram for illustrating an example of an 8-bit XOR operation using phase modulators (part 3).

FIG. 21 is a diagram for illustrating an example of a 6-bit XOR operation using MZI circuits (part 1).

FIG. 22 is a diagram for illustrating an example of an 8-bit XOR operation using MZI circuits (part 1).

FIG. 23 is a diagram for illustrating an example of a 6-bit XOR operation using MZI circuits (part 2).

FIG. 24 is a diagram for illustrating an example of an 8-bit XOR operation using MZI circuits (part 2).

FIG. 25 is a diagram for illustrating an implementation example of MixColumns.

FIG. 26 is a diagram for illustrating an implementation example of entire encryption by AES.

FIG. 27 is a diagram for illustrating an implementation example of an XOR operation for the first round of a key schedule (part 1).

FIG. 28 is a diagram for illustrating an implementation example of an XOR operation for the first round of a key schedule (part 2).

FIG. 29 is a diagram for illustrating an implementation example of an entire key schedule unit.

### DESCRIPTION OF EMBODIMENTS

An embodiment of the present invention will be described below. The present embodiment describes an encryption device 10 that uses optical operation processing to implement an encryption operation of an existing encryption technology (encryption method and authentication method). The authentication method can be considered as a kind of application of the encryption method, and the encryption operation is thus assumed to include not only calculation for encryption and decryption in the encryption method but also calculation for authentication/falsification detection and the like in the authentication method.

### <Configuration Example of Encryption Device 10>

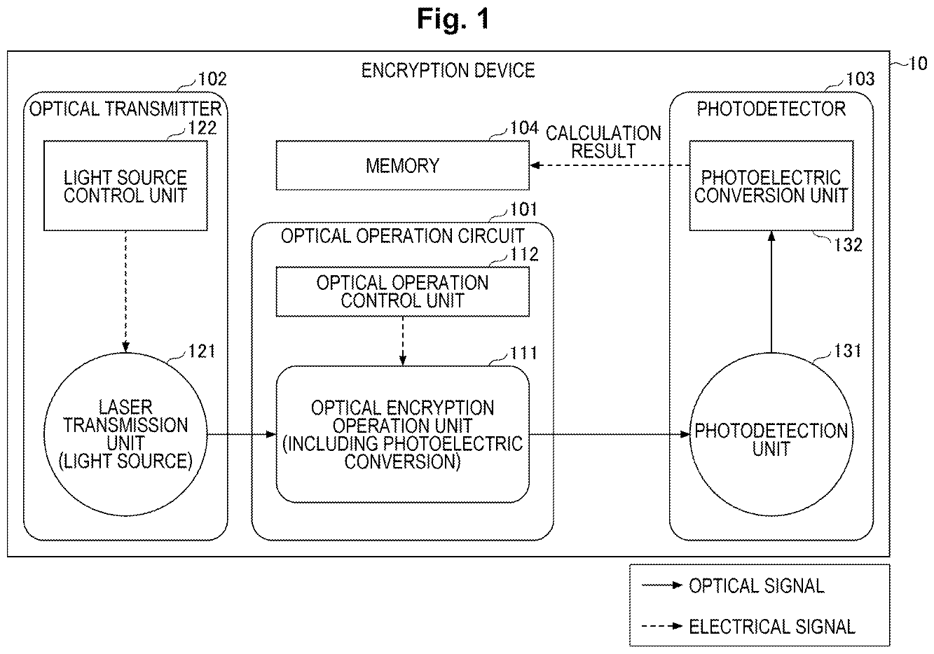

A configuration example of the encryption device 10 according to the present embodiment is illustrated in FIG. 1. As illustrated in FIG. 1, the encryption device 10 according to the present embodiment includes an optical operation circuit 101, an optical transmitter 102, a photodetector 103, and a memory 104.

The optical operation circuit 101 is a circuit (photoelectric fusion processor) that implements optical operation processing. The optical operation circuit 101 functions as an optical encryption operation unit 111 and an optical operation control unit 112 by one or more programs installed on the encryption device 10.

The optical encryption operation unit 111 implements an encryption operation by optical operation processing. In particular, the optical encryption operation unit 111 uses optical operation processing to implement an encryption operation using a multistage operation including XOR operations, a multistage operation including different logical operations such as an XOR operation and an AND operation, or the like. Furthermore, the optical encryption operation unit 111 performs not only optical operation processing but also photoelectric conversion (light-to-electricity conversion) for converting an intermediary value (intermediate value) into an electrical value, for example. In the optical operation processing, an optical signal is input, calculation is conducted in the form of an optical signal, and the calculation result is output in the form of an optical signal.

In a case where electrical signals are used to control a circuit (e.g., an optical switching circuit) that performs optical operation processing, the optical operation control unit 112 performs the control. For example, in a case where a Mach-Zehnder interferometer switch circuit, which is one of optical switching circuits, is used as described later, the optical operation control unit 112 uses an electronic signal to control a path of an optical signal input to the Mach-Zehnder interferometer switch circuit.

The optical transmitter 102 is a device (peripheral device of the optical operation circuit 101) that outputs an optical signal to the optical operation circuit 101. The optical transmitter 102 functions as a laser transmission unit 121 and a light source control unit 122 by one or more programs installed on the encryption device 10.

The laser transmission unit 121 functions as a light source for the optical operation circuit 101, and outputs an optical signal by laser light to the optical operation circuit 101 under the control of the light source control unit 122. Hereinafter, the laser transmission unit 121 is also referred to as the “light source 121”. The light source control unit 122 uses electrical signals to control the laser transmission unit 121 (e.g., performs control such that the laser transmission unit 121 outputs an optical signal).

The photodetector 103 is a device (peripheral device of the optical operation circuit 101) that detects an optical signal output from the optical operation circuit 101 and stores a calculation result represented by the optical signal in the memory 104. The photodetector 103 functions as a photodetection unit 131 and a photoelectric conversion unit 132 by one or more programs installed on the encryption device 10.

The photodetection unit 131 detects an optical signal output from the optical operation circuit 101. The photoelectric conversion unit 132 converts the optical signal detected by the photodetection unit 131 into an electrical signal, and stores, in the memory 104, information represented by the electronic signal (that is, information representing a result of calculation by the optical encryption operation unit 111).

The memory 104 is a storage device that stores information representing a result of calculation by the optical operation circuit 101 (e.g., an encryption result and a decryption result).

The configuration of the encryption device 10 illustrated in FIG. 1 is an example, and, for example, various types of hardware may be included besides the optical operation circuit 101, the optical transmitter 102, the photodetector 103, and the memory 104. Furthermore, the encryption device 10, which is constituted by a plurality of pieces of hardware, may be referred to as an encryption system, for example.

### <AES (Advanced Encryption Standard)>

While the encryption device 10 according to the present embodiment can use optical operation processing to implement an encryption operation for an optional encryption method or authentication method, the following description shows an example of an encryption operation in encryption processing of the AES (Reference Literature 1), which is a de facto standard for common key encryption methods. However, it is needless to say that an encryption operation in AES decryption processing can be implemented in a similar manner. It is needless to say that encryption operations in optional encryption methods and authentication methods such as one-time pad encryption, besides the AES, can be implemented in a similar manner.

The AES is constituted by a data operation unit and a key schedule unit. The data operation unit performs operation processing on data (this operation processing is also called “round processing”) to encrypt (or decrypt) the data, and the key schedule unit generates a round key to be used in the round processing from a secret key. A method of using optical operation processing to implement calculation in the data operation unit and the key schedule unit will be described below.

### <Data Operation Unit>

Round processing by the data operation unit includes four processes of SubBytes, ShiftRows, MixColumns, and AddRoundKey. In general, encryption/decryption processing includes a nonlinear operation unit, and the nonlinear operation unit is implemented by a combination of different logical operations such as an XOR operation and an AND operation. In the AES, SubBytes corresponds to the nonlinear operation unit.

Here, the number of times round processing is executed varies depending on a key length. The length (block length) of plaintext data is 128 bits, and the key length can be 128 bits, 192 bits, or 256 bits. While the present embodiment shows an example in which the key length is 128 bits, equivalent processing can be used for calculation for other key lengths.

An implementation example of the optical operation circuit 101 for realizing each component of the data operation unit of the AES by optical operation processing will be described below.

<<AddRoundKey with Initial Key>>

In the first operation processing of the AES, an XOR operation between 128 bits of an initial key (secret key) generated by the key schedule unit and 128 bits of a plaintext is performed. A 1-bit XOR operation (XOR operation of 128 bits in total) is available in the following three implementation examples (I), (II)-1, and (II)-2.

### Implementation Example (I): Implementation Method in which a Y Gate Circuit is Used

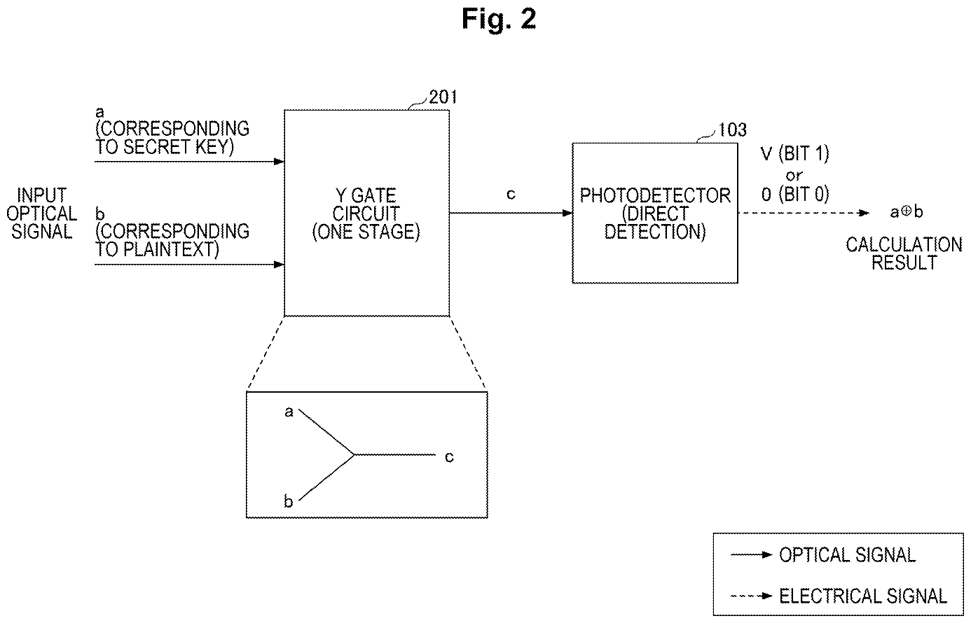

As illustrated in FIG. 2, the optical operation circuit 101 is implemented such that an XOR operation with 2-bit input and 1-bit output is performed by using a Y gate circuit 201. The Y gate circuit 201 receives an optical signal a corresponding to one bit of the secret key and an optical signal b corresponding to one bit of the plaintext, and outputs an optical signal c. The optical signals a and b are output from the light source 121. At this time, it is possible to perform an XOR operation of a and b by shifting a phase difference between the optical signals a and b by π (Reference Literature 2).

The optical signal c after the optical signals a and b have passed through the Y gate circuit 201 is input to the photodetector 103. Then, the photodetection unit 131 of the photodetector 103 detects the optical signal c by direct detection for detecting the intensity of the optical signal, and the photoelectric conversion unit 132 outputs a voltage V or 0 in accordance with the intensity of the optical signal c. That is, the photoelectric conversion unit 132 outputs the voltage V if the intensity of the optical signal c is equal to or greater than a certain threshold, and outputs the voltage 0 if the intensity of the optical signal c is less than the threshold. At this time, the voltage V is set to bit 1, and the voltage 0 is set to bit 0. Thus, the result of the XOR operation of a and b is obtained as an output of the photodetector 103, and is stored in the memory 104.

Here, in order to perform the XOR operation for 128 bits, one Y gate circuit may be used 128 times, or 128 Y gate circuits may be used. It is also possible to perform the XOR operation for 128 bits with less than 128 Y gate circuits by using a plurality of the light sources 121 and using a plurality of optical signals having different frequencies as inputs.

In the present implementation example, the information of the secret key is optical signals, and it is therefore unnecessary to maintain the light state in a method of generating a secret key, and it is preferable to adopt an implementation method in which a key schedule is performed in parallel with encryption (on-the-fly key scheduling).

### Implementation Example (II)-1: Implementation Method in which a Mach-Zehnder Interferometer Switch Circuit is Used

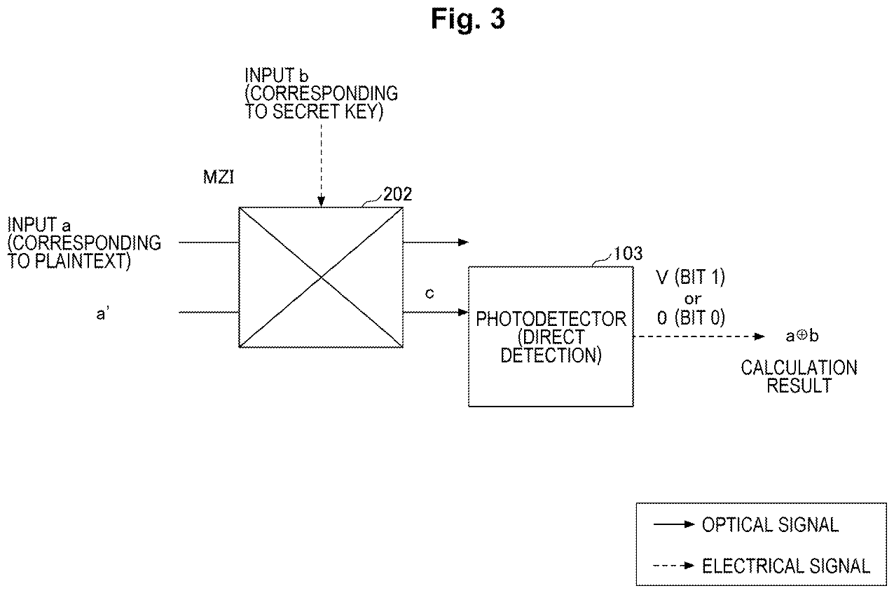

As illustrated in FIG. 3, the optical operation circuit 101 is implemented such that an XOR operation with 2-bit input and 1-bit output is performed by using a Mach-Zehnder interferometer switch circuit (hereinafter referred to as an MZI circuit) 202. This implementation method is desirable in a case of electrically retaining a secret key.

When information representing the secret key is electrically retained, an electrical signal b corresponding to one bit of the secret key is allocated to an input of the MZI circuit 202, and an optical signal a corresponding to one bit of the plaintext and an optical signal a′ obtained by inverting a bit value of the optical signal a are allocated to an upper optical signal port and a lower optical signal port, respectively, as inputs to a path of the MZI circuit 202. In a case where a is an optical signal representing bit 1, a′ is an optical signal representing bit 0, and in a case where a is an optical signal representing bit 0, a′ is an optical signal representing bit 1. The optical signals a and a′ are output from the light source 121.

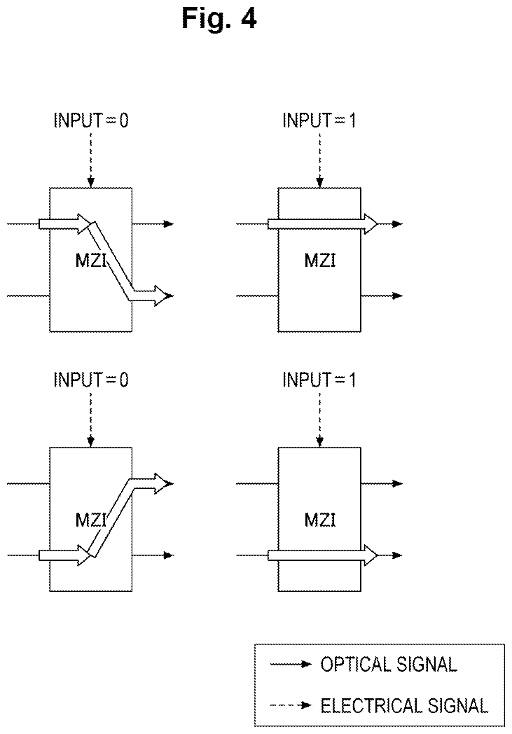

Here, as illustrated in FIG. 4, in an MZI circuit, if an input electrical signal is 0, the path of the optical signal is changed (this is called a cross state, in which an optical signal input from the upper optical signal port is output from the lower optical signal port, and an optical signal input from the lower optical signal port is output from the upper optical signal port), and if an electrical signal is 1, the optical signal is allowed to pass through with no change (this is called a bar state). Hereinafter, a port to which an electronic signal is input is also called a path control port.

The paths of the optical signals a and a′ are controlled by the value of the electrical signal b corresponding to one bit of the secret key, and the value represented by an optical signal output from the lower optical signal port of the MZI circuit 202 is equivalent to the result of the XOR operation of a and b. That is, when the optical signal output from the lower optical signal port of the MZI circuit 202 is denoted by c, if the photodetection unit 131 of the photodetector 103 has detected an optical signal c (that is, if an optical signal c having a certain intensity or higher has reached the photodetector 103), the photoelectric conversion unit 132 outputs the voltage V, and if not, the photoelectric conversion unit 132 outputs the voltage 0. At this time, the voltage V is set to bit 1, and the voltage 0 is set to bit 0. Thus, the result of the XOR operation of a and b is obtained as an output of the photodetector 103, and is stored in the memory 104.

Here, in order to perform the XOR operation for 128 bits, one MZI circuit may be used 128 times, or 128 MZI circuits may be used. It is also possible to perform the XOR operation for 128 bits with less than 128 MZI circuits by using a plurality of the light sources 121 and using a plurality of optical signals having different frequencies as inputs.

### Implementation Example (II)-2: Implementation Method in which an MZI Circuit with Two Input Ports is Used

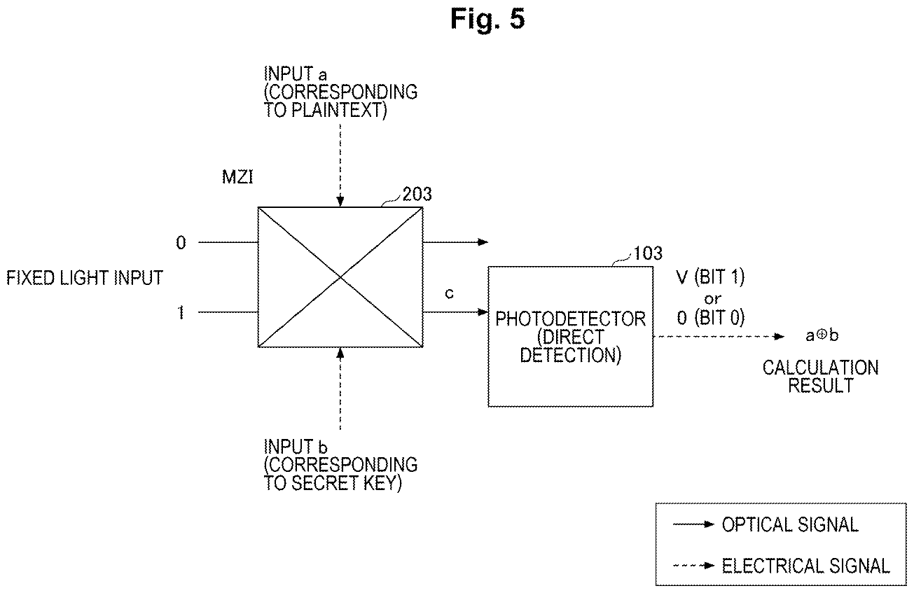

As illustrated in FIG. 5, the optical operation circuit 101 is implemented such that an XOR operation with 2-bit input and 1-bit output is performed by using an MZI circuit having two path control ports (hereinafter also referred to as a 2-input port MZI circuit) 203 for controlling a path of an optical signal.

At this time, as fixed optical signals, an optical signal representing bit 0 and an optical signal representing bit 1 are input to the upper optical signal port and the lower optical signal port, respectively, of the 2-input port MZI circuit 203, and two electrical signals (an electrical signal a corresponding to one bit of the plaintext and an electrical signal b corresponding to one bit of the secret key) are individually input to two path control ports. The fixed optical signals are output from the light source 121.

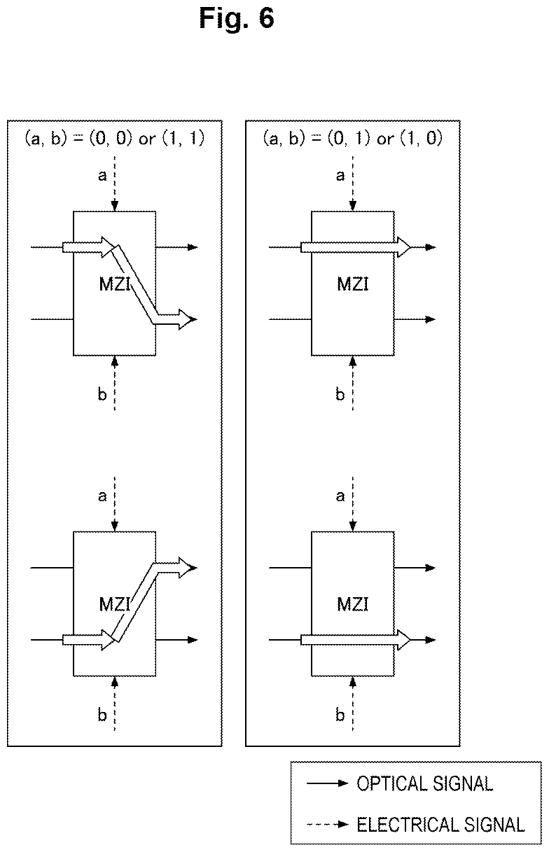

Here, as illustrated in FIG. 6, if the values of the two electrical signals a and b are both 1 or 0, the 2-input port MZI circuit enters the cross state, and if not, the circuit enters the bar state.

Therefore, the paths of the optical signals are controlled by the value of the electrical signal a corresponding to one bit of the plaintext and the value of the electrical signal b corresponding to one bit of the secret key, and a value represented by an optical signal output from the lower optical signal port of the 2-input port MZI circuit 203 is equivalent to the result of the XOR operation of a and b. That is, when the optical signal output from the lower optical signal port of the 2-input port MZI circuit 203 is denoted by c, if the photodetection unit 131 of the photodetector 103 has detected an optical signal c (that is, if an optical signal c having a certain intensity or higher has reached the photodetector 103), the photoelectric conversion unit 132 outputs the voltage V, and if not, the photoelectric conversion unit 132 outputs the voltage 0. At this time, the voltage V is set to bit 1, and the voltage 0 is set to bit 0. Thus, the result of the XOR operation of a and b is obtained as an output of the photodetector 103, and is stored in the memory 104. In the present implementation example, it is necessary to electrically retain both the plaintext as a target of the XOR operation and the secret key in advance (or convert the optical signals into electrical signals).

Here, as in the implementation example (II)-1, in order to perform the XOR operation for 128 bits, one 2-input port MZI circuit may be used 128 times, or 128 2-input port MZI circuits may be used. It is also possible to perform the XOR operation for 128 bits with less than 128 2-input port MZI circuits by using a plurality of the light sources 121 and inputting a plurality of optical signals having different frequencies as fixed optical signals.

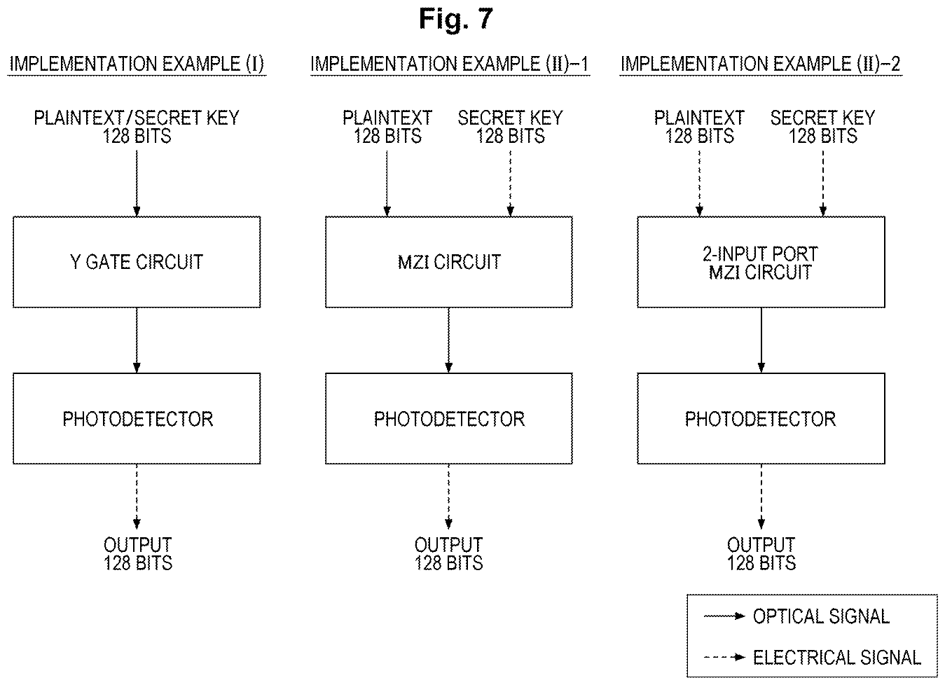

FIG. 7 collectively illustrates the above implementation examples (I), (II)-1, and (II)-2. As illustrated in FIG. 7, in the implementation example (I), both the plaintext and the secret key are input as optical signals to the Y gate circuit. In the implementation example (II)-1, the plaintext is input as an optical signal and the secret key is input as an electrical signal to the MZI circuit. In the implementation example (II)-2, both the plaintext and the secret key are input as electrical signals to the 2-input port MZI circuit.

### <<SubBytes>>

SubBytes processing of the AES includes a case where a table conversion table called S-Box is used and a case where affine transformation constituted by an inverse operation over an extension field (GF(2⁸)) and an XOR operation is used. Hereinafter, a case where a table conversion table is used will be described.

As an example, SubBytes (8-bit input, 8-bit output) used for encryption in the AES will be described (Reference Literature 1). SubBytes used for decryption can be configured in a similar manner.

In the present embodiment, an implementation example will be described in which an electrical signal representing an 8-bit input of SubBytes is input and an optical signal representing one bit of an 8-bit output of SubBytes is output by using an optical pass gate logic circuit (Reference Literature 3).

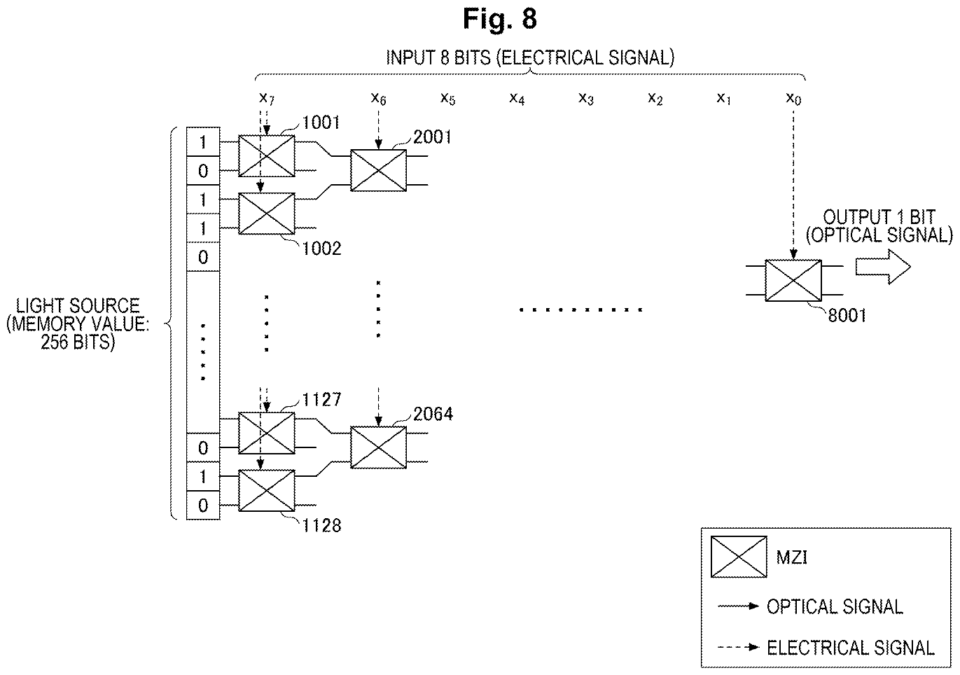

FIG. 8 illustrates an implementation example in which an 8-bit input of SubBytes is (x₇x₆x₅x₄x₃x₂x₁x₀)₂ and the least significant one bit of the 8-bit output of SubBytes is output. As illustrated in FIG. 8, the optical operation circuit 101 is implemented by using MZI circuits as follows: a first stage constituted by 128 MZI circuits 1001 to 1128 in which an electrical signal x₇ is input to the path control port, a second stage constituted by 64 MZI circuits 2001 to 2054 in which an electrical signal x₆ is input to the path control port, a third stage constituted by 32 MZI circuits 3001 to 3032 in which an electrical signal x₅ is input to the path control port, a fourth stage constituted by 16 MZI circuits 4001 to 4016 in which an electrical signal x₄ is input to the path control port, a fifth stage constituted by 8 MZI circuits 5001 to 5008 in which an electrical signal x₃ is input to the path control port, a sixth stage constituted by 4 MZI circuits 6001 to 6004 in which an electrical signal x₂ is input to the path control port, a seventh stage constituted by 2 MZI circuits 7001 and 7002 in which an electrical signal x₁ is input to the path control port, and an eighth stage constituted by 1 MZI circuit 8001 in which an electrical signal x₀ is input to the path control port. In FIG. 8, only some of the MZI circuits are illustrated, and the other circuits are not illustrated.

At this time, the MZI circuits are connected with each other such that optical signals output from the upper optical signal ports of two MZI circuits in the previous stage are input to the optical signal ports of an MZI circuit in the next stage. Specifically, as illustrated in FIG. 8, an optical signal output from the upper optical signal port of the MZI circuit 1001 and an optical signal output from the upper optical signal port of the MZI circuit 1002 are respectively input to the upper optical signal port and the lower optical signal port of the MZI circuit 2001. That is, for example, the MZI circuits in each stage are assigned with numbers from the top, starting from 0. At this time, for i=0, 2, 4, . . . , 126, an optical signal output from the upper optical signal port of the i-th MZI circuit in the first stage and an optical signal output from the upper optical signal port of the (i+1)-th MZI circuit in the first stage are respectively input to the upper optical signal port and the lower optical signal port of the i/2-th MZI circuit in the second stage. Similarly, for i=0, 2, 4, . . . , 62, an optical signal output from the upper optical signal port of the i-th MZI circuit in the second stage and an optical signal output from the upper optical signal port of the (i+1)-th MZI circuit in the second stage are respectively input to the upper optical signal port and the lower optical signal port of the i/2-th MZI circuit in the third stage. Similarly thereafter, for i=0, 2, 4, . . . , 30, an optical signal output from the upper optical signal port of the i-th MZI circuit in the third stage and an optical signal output from the upper optical signal port of the (i+1)-th MZI circuit in the third stage are respectively input to the upper optical signal port and the lower optical signal port of the i/2-th MZI circuit in the fourth stage. For i=0, 2, 4, . . . , 14, an optical signal output from the upper optical signal port of the i-th MZI circuit in the fourth stage and an optical signal output from the upper optical signal port of the (i+1)-th MZI circuit in the fourth stage are respectively input to the upper optical signal port and the lower optical signal port of the i/2-th MZI circuit in the fifth stage. For i=0, 2, 4, and 6, an optical signal output from the upper optical signal port of the i-th MZI circuit in the fifth stage and an optical signal output from the upper optical signal port of the (i+1)-th MZI circuit in the fifth stage are respectively input to the upper optical signal port and the lower optical signal port of the i/2-th MZI circuit in the sixth stage. For i=0 and 2, an optical signal output from the upper optical signal port of the i-th MZI circuit in the sixth stage and an optical signal output from the upper optical signal port of the (i+1)-th MZI circuit in the sixth stage are respectively input to the upper optical signal port and the lower optical signal port of the i/2-th MZI circuit in the seventh stage. An optical signal output from the upper optical signal port of the 0-th MZI circuit in the seventh stage and an optical signal output from the upper optical signal port of the first MZI circuit in the seventh stage are respectively input to the upper optical signal port and the lower optical signal port of the MZI circuit in the eighth stage.

Furthermore, in the memory 104, the least significant bit of an output result obtained by inputting each byte (0x00 to 0xFF in hexadecimal notation) to SubBytes is allocated as a memory value. For example, the output of SubBytes for 0x00 is 0x63, and thus, 1, which is the least significant bit of 0x63, is allocated to the top (most significant bit) of the memory value. Similarly, the output of SubBytes for 4x01 is 0x7c, and thus, 0, which is the least significant bit of 0x7c, is allocated to the second value (next to the top) in the memory value. Similarly thereafter, the least significant bit of the output of SubBytes for each of 0x02 to 0xFF is sequentially allocated to the memory value.

Then, for i=0, . . . , 127, an optical signal representing the 2i-th value from the top in the memory value and an optical signal representing the (2i+1)-th value are respectively input to the upper optical signal port and the lower optical signal port of the i-th MZI circuit in the first stage. These optical signals are output from the light source 121.

Thus, one bit represented by an optical signal output from the upper optical signal port of the MZI circuit 8001 in the eighth stage is the least significant one bit of the output of SubBytes for (x₇x₆x₅x₄x₃x₂x₁x₀)₂. Note that the optical signal output from the upper optical signal port of the MZI circuit 8001 is detected by the photodetector 103, and a 1-bit value represented by the optical signal is stored in the memory 104. Specifically, when the photodetection unit 131 of the photodetector 103 has detected an optical signal having an intensity equal to or greater than a certain threshold, the photoelectric conversion unit 132 outputs the voltage V corresponding to bit 1, and the photoelectric conversion unit 132 outputs the voltage 0 corresponding to bit 0 at other times.

By implementing the optical operation circuit 101 as described above and controlling the path of each MZI circuit in accordance with a combination of (x₇x₆x₅x₄x₃x₂x₁x₀)₀ input to SubBytes, any value (0 or 1) in 256 (=2⁸) memory values can be output as the least significant bit of the 8-bit output of SubBytes.

Similarly, for the other bits of the 8-bit output of SubBytes, a value of the corresponding bit of an output result obtained by inputting each byte to SubBytes is allocated as a memory value, and thus, implementation is available. That is, in a case of outputting a value of the n-th bit (n=0, 1, . . . , 7) of the 8-bit output of SubBytes, the value of the n-th bit of an output result obtained by inputting each byte to SubBytes can be allocated as a memory value. Note that the bit of n=0 corresponds to the least significant bit.

The relationship between the input/output and the memory value in a case of implementing SubBytes by using an optical pass gate logic circuit is summarized below.
Input of optical pass gate logic circuit: 8-bit input of SubBytes
Output of optical pass gate logic circuit: Value of n-th bit of 8-bit output of SubBytes (n=0, 1, . . . , 7)
Memory value: 256-bit value in which the value of the n-th bit of an output result (8 bits) obtained by inputting, to SubBytes, each of bytes 0x00 to 0xFF is stored in order from the top (the most significant) (n=0, . . . , 7)

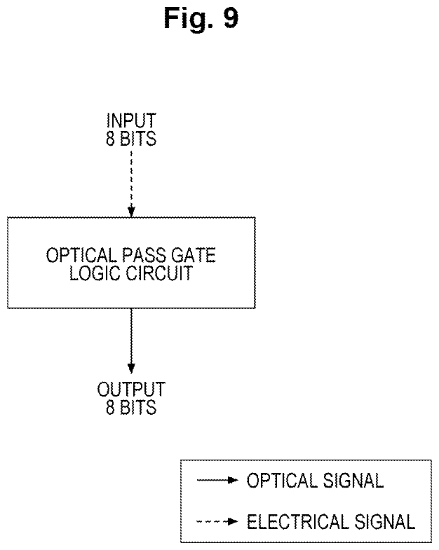

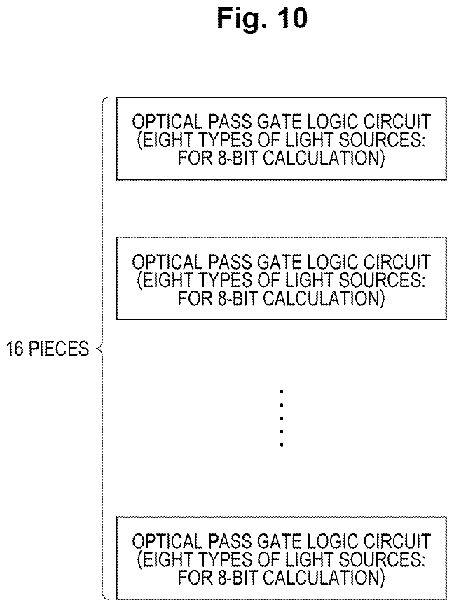

FIG. 9 illustrates an implementation example of SubBytes described above. As illustrated in FIG. 9, an 8-bit electrical signal is input and an 8-bit optical signal is output in the present implementation example. Since the AES requires 16 8-bit input/output SubBytes, in a case where, for example, calculation for 8 bits is multiplexed with one optical pass gate logic circuit using eight types of light sources (that is, eight types of memory values), 16 optical pass gate logic circuits need to be implemented. On the other hand, for example, in a case where eight optical pass gate logic circuits are implemented using one light source, 8×16=128 optical pass gate logic circuits are required. FIG. 10 illustrates, as an example, an implementation example of a case of multiplexing with one optical pass gate logic circuit using eight types of light sources. In the implementation example illustrated in FIG. 10, optical pass gate logic circuits capable of performing calculation for eight bits with eight types of built-in light sources are arranged in parallel, and this allows for prevention of a delay due to calculation.

### <<Shift Rows>>

Operation processing of ShiftRows is performed by changing the connection of optical wiring. In the AES, a 0, 8, 16, or 24-bit cyclic shift is performed depending on the position of the intermediate value, and the optical operation circuit 101 is implemented such that the optical wiring of each bit is physically connected in accordance with the arrangement after the cyclic shift.

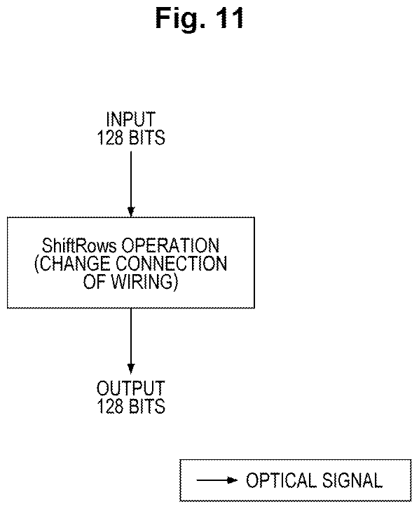

FIG. 11 illustrates an implementation example of ShiftRows described above. As illustrated in FIG. 11, an optical signal is input and an optical signal is output in the present implementation example.

### <<MixColumns and AddRoundKey>>

MixColumns and AddRoundKey in the AES are different types of operation processing (Reference Literature 1), and the present embodiment is based on the assumption that these two types of operation processing are simultaneously implemented.

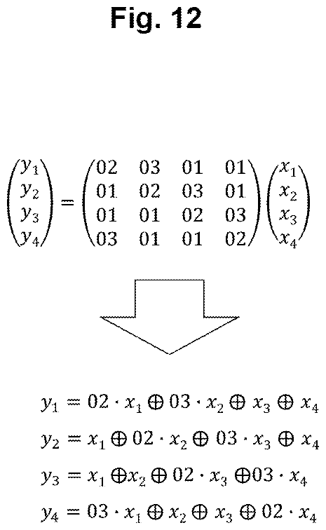

MixColumns is operation processing corresponding to transposition in the AES, and is implemented by multiplication of a 32-bit matrix as illustrated in FIG. 12. Here, y₁ to y₄ are elements of the extension field GF(2⁸) (irreducible polynomial: x⁸+x⁴+x³+x+1) (xᵢ, yᵢ: 8 bits, i=1, 2, 3, 4). Here, y₁ expressed by the following Formula (1) is considered. Note that y₂ to y₄ can be calculated in a similar manner to y₁.

$$\\ \begin{matrix}[ Math . 1 ] & \\ {y}_{1} = 02 \cdot {x}_{1} ⊕ 03 \cdot {x}_{2} ⊕ {x}_{3} ⊕ {x}_{4} & ( 1 )\end{matrix}$$

Here, x₁ to x₄, which are 8-bit values, are expressed in binary numbers, and are expressed as follows. Note that aᵢ, bᵢ, cᵢ, and dᵢ are 1-bit values, i=0, . . . , 7 holds, and i=0 is the least significant bit.
x₁:(a₇a₆a₅a₄a₃a₂a₁a₀)₂
x₂:(b₇b₆b₅b₄b₃b₂b₁b₀)₂
x₃: (c₇c₆c₅c₄c₃c₂c₁c₀)₂
x₄: (d₇d₆d₅d₄d₃d₂d₁d₀)₂

At this time, each bit of the binary representation (y₁⁷y₁⁶y₁⁵y₁⁴y₁³y₁²y₁¹y₁⁰)₂ of y₁ can be expressed as follows.

Note that y₁⁰ is the least significant bit.

$$\\ \begin{matrix}[ Math . 2 ] & \\ {y}_{1}^{{}_{} 0} : ( {a}_{7} ⊕ {b}_{0} ⊕ {b}_{7} ⊕ {c}_{0} ⊕ {d}_{0} ) & \end{matrix}$$

$$\\ {y}_{1}^{{}_{} 1} : ( {a}_{0} ⊕ {a}_{7} ⊕ {b}_{0} ⊕ {b}_{1} ⊕ {b}_{7} ⊕ {c}_{1} ⊕ {d}_{1} )$$

$$\\ {y}_{1}^{{}_{} 2} : ( {a}_{1} ⊕ {b}_{1} ⊕ {b}_{2} ⊕ {c}_{2} ⊕ {d}_{2} )$$

$$\\ {y}_{1}^{{}_{} 3} : ( {a}_{2} ⊕ {a}_{7} ⊕ {b}_{2} ⊕ {b}_{3} ⊕ {b}_{7} ⊕ {c}_{3} ⊕ {d}_{3} )$$

$$\\ {y}_{1}^{{}_{} 4} : ( {a}_{3} ⊕ {a}_{7} ⊕ {b}_{3} ⊕ {b}_{4} ⊕ {b}_{7} ⊕ {c}_{4} ⊕ {d}_{4} )$$

$$\\ {y}_{1}^{{}_{} 5} : ( {a}_{4} ⊕ {b}_{4} ⊕ {b}_{5} ⊕ {c}_{5} ⊕ {d}_{5} )$$

$$\\ {y}_{1}^{{}_{} 6} : ( {a}_{5} ⊕ {b}_{5} ⊕ {b}_{6} ⊕ {c}_{6} ⊕ {d}_{6} )$$

$$\\ {y}_{1}^{{}_{} 7} : ( {a}_{6} ⊕ {b}_{6} ⊕ {b}_{7} ⊕ {c}_{7} ⊕ {d}_{7} )$$

Here, consideration is given to executing AddRoundKey, which is processing to be performed subsequent to MixColumns, simultaneously with the above XOR operation. That is, consideration is given to performing an XOR operation with a round key simultaneously with calculation of y₁.

When the number of rounds is denoted by i and the number of bytes is denoted by j, the round key (8 bits) is expressed by RKⱼⁱ(i=1, . . . , 9, j=0, . . . , 15). The binary notation of the round key for an XOR operation with y₁ is expressed as follows.
RK₀ⁱ:(rk₇rk₆rk₅rk₄rk₃rk₂rk₁rk₀)₂

At this time, when an XOR operation (that is, the operation of MixColumns) for obtaining y₁ and an XOR operation of y₁ and the round key are simultaneously performed, the following expression can be obtained.

$$\\ \begin{matrix}[ Math . 3 ] & \\ {y}_{1}^{{}_{} 0} ⊕ {rk}_{0} : ( {a}_{7} ⊕ {b}_{0} ⊕ {b}_{7} ⊕ {c}_{0} ⊕ {d}_{0} ⊕ {rk}_{0} ) & \end{matrix}$$

$$\\ {y}_{1}^{{}_{} 1} ⊕ {rk}_{1} : ( {a}_{0} ⊕ {a}_{7} ⊕ {b}_{0} ⊕ {b}_{1} ⊕ {b}_{7} ⊕ {c}_{1} ⊕ {d}_{1} ⊕ {rk}_{1} )$$

$$\\ {y}_{1}^{{}_{} 2} ⊕ {rk}_{2} : ( {a}_{1} ⊕ {b}_{1} ⊕ {b}_{2} ⊕ {c}_{2} ⊕ {d}_{2} ⊕ {rk}_{2} )$$

$$\\ {y}_{1}^{{}_{} 3} ⊕ {rk}_{3} : ( {a}_{2} ⊕ {a}_{7} ⊕ {b}_{2} ⊕ {b}_{3} ⊕ {b}_{7} ⊕ {c}_{3} ⊕ {d}_{3} ⊕ {rk}_{3} )$$

$$\\ {y}_{1}^{{}_{} 4} ⊕ {rk}_{4} : ( {a}_{3} ⊕ {a}_{7} ⊕ {b}_{3} ⊕ {b}_{4} ⊕ {b}_{7} ⊕ {c}_{4} ⊕ {d}_{4} ⊕ {rk}_{4} )$$

$$\\ {y}_{1}^{{}_{} 5} ⊕ {rk}_{5} : ( {a}_{4} ⊕ {b}_{4} ⊕ {b}_{5} ⊕ {c}_{5} ⊕ {d}_{5} ⊕ {rk}_{5} )$$

$$\\ {y}_{1}^{{}_{} 6} ⊕ {rk}_{6} : ( {a}_{5} ⊕ {b}_{5} ⊕ {b}_{6} ⊕ {c}_{6} ⊕ {d}_{6} ⊕ {rk}_{6} )$$

$$\\ {y}_{1}^{{}_{} 7} ⊕ {rk}_{7} : ( {a}_{6} ⊕ {b}_{6} ⊕ {b}_{7} ⊕ {c}_{7} ⊕ {d}_{7} ⊕ {rk}_{7} )$$

From the above, it can be seen that it is necessary to perform a 6-bit XOR operation and an 8-bit XOR operation in order to simultaneously perform calculation of MixColumns and AddRoundKey.

Now, three types of implementation examples of a case where a 6-bit XOR operation and an 8-bit XOR operation are implemented by optical operation processing will be described below. While the description below shows, as an example, a case where an XOR operation of y₁⁰ and rk₀ is performed in the 6-bit XOR operation and an XOR operation of y₁¹ and rk₁ is performed in the 8-bit XOR operation, another 6-bit XOR operation (XOR operation of y₁² and rk₂, XOR operation of y₁⁵ and rk₅, XOR operation of y₁⁶ and rk₆, or XOR operation of y₁⁷ and rk₇) or another 8-bit XOR operation (XOR operation of y₁³ and rk₃, or XOR operation of y₁⁴ and rk₄) can be implemented with one circuit by using a multi-wavelength light source.

### Implementation Example (A): Implementation Method in which a Bit is Expressed by Amplitude (or Intensity) of Light

An implementation example of encoding into bit 1 or bit 0 in accordance with the amplitude (or intensity) of an optical signal will be described. In this implementation example, the amplitudes of light beams are superimposed on each other by using a Y gate circuit, and thus a 6-bit XOR operation or an 8-bit XOR operation is implemented.

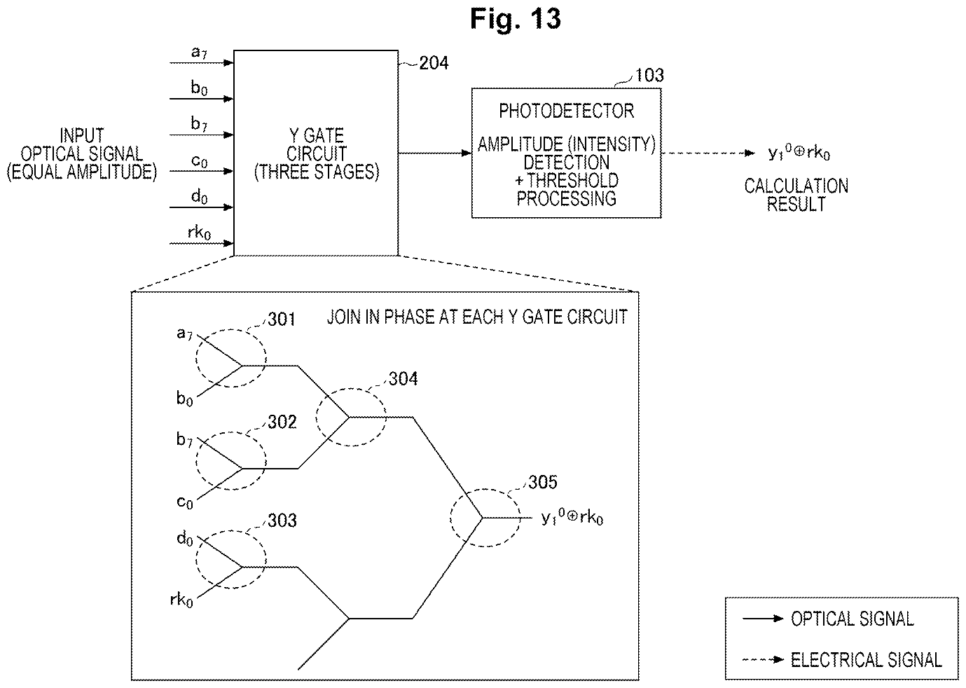

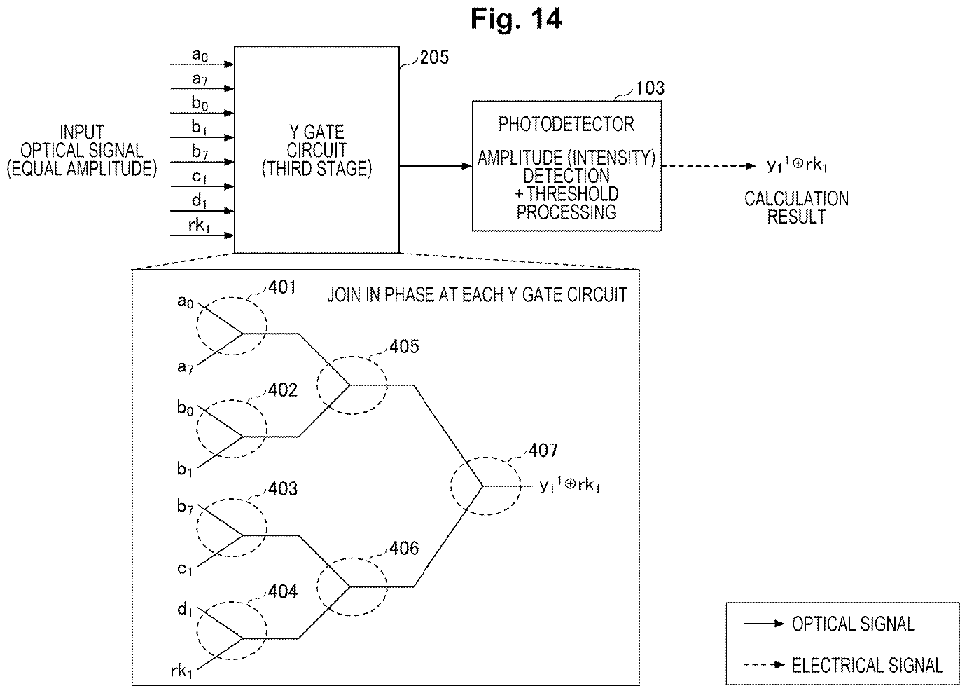

FIG. 13 illustrates an implementation example of the optical operation circuit 101 in a case where a 6-bit XOR operation is performed. FIG. 14 illustrates an implementation example of the optical operation circuit 101 in a case where an 8-bit XOR operation is performed.

In a case of performing a 6-bit XOR operation, as illustrated in FIG. 13, the optical operation circuit 101 is implemented by a Y gate circuit 204 constituted by three stages using five Y gate circuits 301 to 305, and optical signals a₇, b₀, b₇, c₀, d₀, and rk₀ having equal amplitudes are superimposed in phase (same phase) by the Y gate circuit 204. The optical signals a₇, b₀, b₇, c₀, d₀, and rk₀ are output from the light source 121.

At this time, the amplitude (or intensity) of an optical signal output from the Y gate circuit 204 increases in accordance with the number of superimposed optical signals corresponding to bit 1. For the purpose of superimposing two optical signals in the same phase, a phase shifter for adjustment may be used in one of the paths of the Y gate circuit.

Therefore, the amplitude (or intensity) of the optical signal output from the Y gate circuit 204 may be detected by the photodetection unit 131 of the photodetector 103, and the photoelectric conversion unit 132 may perform threshold processing on the basis of the detection result and output an electrical signal corresponding to bit 0 or 1. Homodyne detection may be used to detect the amplitude of the optical signal, and direct detection may be used to detect the intensity.

In the threshold processing by the photoelectric conversion unit 132, an electrical signal corresponding to bit 0 or 1 is output depending on how many times of the amplitude (or intensity) of a single optical signal corresponding to bit 1 at the time of detection by the photodetection unit 131 is equivalent to the amplitude (or intensity) of the optical signal detected by the photodetection unit 131. That is, for example, the photoelectric conversion unit 132 stores in advance, in the memory 104, information in which a multiple and a bit value are associated with each other as follows (that is, information in which an even multiple (including 0 times) is associated with 0, and an odd multiple is associated with 1).
6 times→0
5 times→1
4 times→0
3 times→1
2 times→0
1 times→1
0 times→0

Then, the photoelectric conversion unit 132 may determine how many times of the amplitude (or intensity) of a single optical signal corresponding to bit 1 is equivalent to the amplitude (or intensity) of the optical signal detected by the photodetection unit 131, and output the bit value corresponding to the multiple. This bit value is the result of the XOR operation of y₁⁰ and rk₀ (the result of the 6-bit XOR operation), and is stored in the memory 104. Unlike the implementation examples (B) and (C) to be described later, it is not necessary to perform photoelectric conversion when calculating the bit value represented by the optical signal output from the Y gate circuit 204 in the present implementation example.

In a case of performing an 8-bit XOR operation, as illustrated in FIG. 14, the optical operation circuit 101 is implemented by a Y gate circuit 205 constituted by three stages using seven Y gate circuits 401 to 407, and optical signals a₀, a₇, b₀, b₁, b₇, c₁, d₁, and rk₁ having equal amplitudes are superimposed in phase (same phase) by the Y gate circuit 205. The optical signals a₀, a₇, b₀, b₁, b₇, c₁, d₁, and rk₁ are output from the light source 121.

At this time, similarly to the 6-bit XOR operation, the amplitude (or intensity) of an optical signal output from the Y gate circuit 205 increases in accordance with the number of superimposed optical signals corresponding to bit 1. Thus, similarly to the 6-bit XOR operation, the amplitude (or intensity) of the optical signal output from the Y gate circuit 205 may be detected by the photodetection unit 131 of the photodetector 103, and the photoelectric conversion unit 132 may perform threshold processing on the basis of the detection result and output an electrical signal corresponding to bit 0 or 1. Note that, in the threshold processing, similarly to the 6-bit XOR operation, the determination result may be 0 in a case of an even multiple (including 0 times), and 1 in a case of an odd multiple. This bit value is the result of the XOR operation of y₁¹ and rk₁ (the result of the 8-bit XOR operation), and is stored in the memory 104.

### Implementation Example (B): Implementation Method in which a Bit is Expressed by a Phase Difference Between Light Beams (Using a Phase Modulator)

An implementation example will be described in which bit 1 or bit 0 is encoded depending on a phase difference between two light beams by using a phase modulator (PM).

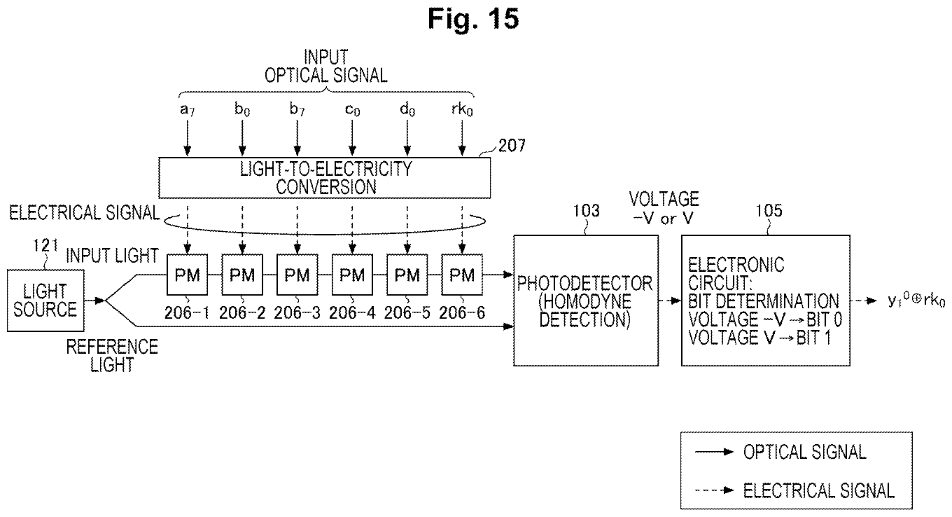

FIG. 15 illustrates an implementation example of the optical operation circuit 101 in a case where a 6-bit XOR operation is performed. As illustrated in FIG. 15, the optical operation circuit 101 is implemented such that six PMs 206-1 to 206-6 are connected in series, and optical signals from the light source 121 are divided into two branches and output to the PM 206-1 and the photodetection unit 131. Since the PMs 206-1 to 206-6 receive electrical signals, photoelectric conversion 207 for converting the optical signals a₇, b₀, b₇, c₀, d₀, and rk₀ into electrical signals is also implemented in the optical operation circuit 101. Furthermore, an electronic circuit 105 that receives an electrical signal from the photodetector 103 and performs bit determination is implemented. An optical signal (optical signal on the upper side in the drawing) output to the PM 206-1 is called input light, and an optical signal (optical signal on the lower side in the drawing) directly output to the photodetection unit 131 is called reference light.

At this time, each of the PMs 206-1 to 206-6 shifts the phase of the input light by π if the value of the electrical signal input to the PM is 1, and outputs the input light as it is if the value of the electrical signal input to the PM is 0. Accordingly, in a case where an even number (including 0 number) of a₇, b₀, b₇, c₀, d₀, and rk₀ is 1, the phase difference between the input light and the reference light is 0, and in a case where an odd number of them is 1, the phase difference between the input light and the reference light is π. For example, in a case where the number of bits 1 among a₇, b₀, b₇, c₀, d₀, and rk₀ is two, the phase of the input light is 2π, and thus the phase difference from the reference light is 0. On the other hand, for example, in a case where the number of bits 1 is three, the phase of the input light is 3π, and thus the phase difference from the reference light is n.

Thus, the phase difference between the input light and the reference light is detected by the photodetection unit 131 of the photodetector 103 by homodyne detection (or heterodyne detection), and the photoelectric conversion unit 132 outputs a voltage −V if the detected phase difference is 0, and outputs a voltage V if the detected phase difference is π. Then, the electronic circuit 105 determines that the bit is 0 if the voltage −V has been input, and determines that the bit is 1 if the voltage V has been input, and then outputs an electrical signal representing the determination result. The value represented by this electrical signal is the result of the XOR operation of y₁⁰, and rk₀ (the result of the 6-bit XOR operation), and is stored in the memory 104. Note that the photodetection unit 131 can detect an optical signal by heterodyne detection, but in that case, it is necessary to use reference light slightly shifted from the phase of the input light.

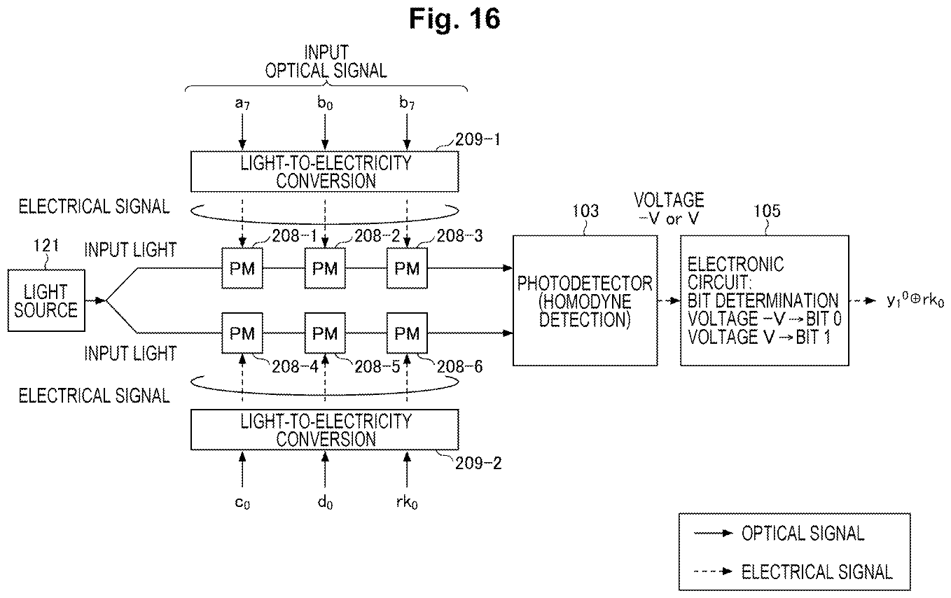

As illustrated in FIG. 16, it is also possible to implement the optical operation circuit 101 that performs a 6-bit XOR operation without using reference light. In this implementation example, PMs 208-1 to 208-3 are arranged on the upper side, PMs 208-4 to 208-6 are arranged on the lower side, and input light from the light source 121 is divided into two branches. In addition, photoelectric conversion 209-1 for converting the optical signals a₇, b₀, and b₇ into electrical signals and photoelectric conversion 209-2 for converting the optical signals c₀, d₀, and rk₀ into electrical signals are implemented. In this implementation example, as in the implementation example illustrated in FIG. 15, each of the PMs 208-1 to 208-6 shifts the phase of the input light by π if the value of the electrical signal input to the PM is 1, and outputs the input light as it is if the value of the electrical signal input to the PM is 0. As a result, as in the implementation example illustrated in FIG. 15, whether the phase difference is 0 or π is detected by the photodetector 103, and in accordance with a result of the detection, an electrical signal representing the result of the XOR operation of y₁⁰ and rk₀ (the result of the 6-bit XOR operation) is output from the electronic circuit 105. The implementation example illustrated in FIG. 16 has an advantage that a signal delay is shorter as compared with the implementation example illustrated in FIG. 15.

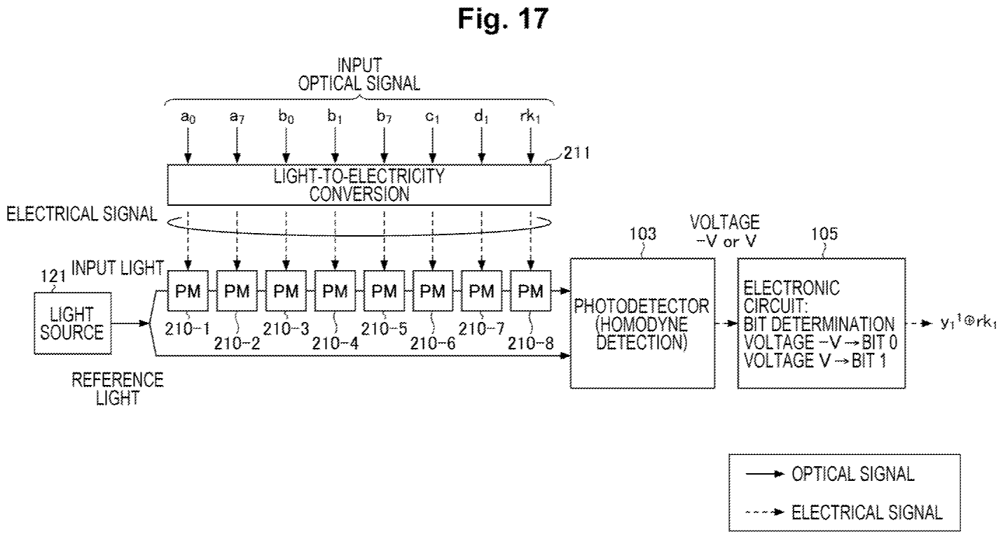

FIG. 17 illustrates an implementation example of the optical operation circuit 101 in a case where an 8-bit XOR operation is performed. The implementation example illustrated in FIG. 17 is obtained by extending the implementation example illustrated in FIG. 15 to an 8-bit XOR operation, in which eight PMs 210-1 to 210-8 are connected in series, and photoelectric conversion 211 for converting the optical signals a₀, a₇, b₀, b₁, b₇, c₁, d₁, and rk₁ into electrical signals is implemented in the optical operation circuit 101. The other points are similar to those in the implementation example illustrated in FIG. 15. As a result, in the implementation example illustrated in FIG. 17, whether the phase difference is 0 or π is detected by the photodetector 103, and in accordance with a result of the detection, an electrical signal representing the result of the XOR operation of y₁¹ and rk₁ (the result of the 8-bit XOR operation) is output from the electronic circuit 105.

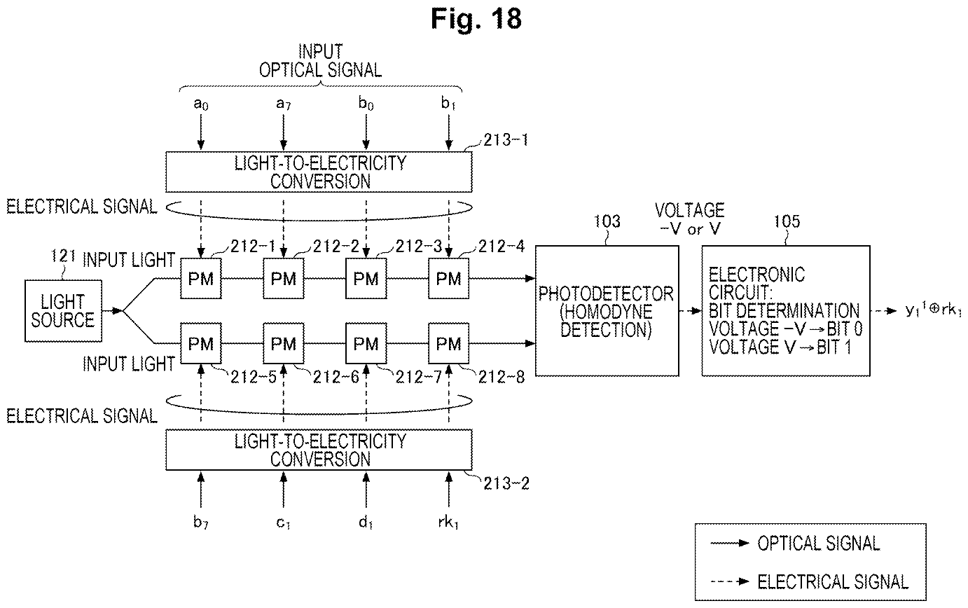

As illustrated in FIG. 18, it is also possible to implement the optical operation circuit 101 that performs an 8-bit XOR operation without using reference light. This implementation example is obtained by extending the implementation example illustrated in FIG. 16 to an 8-bit XOR operation, in which PMs 212-1 to 212-4 are arranged on the upper side and PMs 212-5 to 212-8 are arranged on the lower side, and photoelectric conversion 213-1 for converting the optical signals a₀, a₇, b₀, and b₁ into electrical signals and photoelectric conversion 213-2 for converting the optical signals b₇, c₁, d₁, and rk₁ into electrical signals are implemented. The other points are similar to those in the implementation example illustrated in FIG. 16. As a result, also in the implementation example illustrated in FIG. 18, whether the phase difference is 0 or π is detected by the photodetector 103, and in accordance with a result of the detection, an electrical signal representing the result of the XOR operation of y₁¹ and rk₁ (the result of the 8-bit XOR operation) is output from the electronic circuit 105.

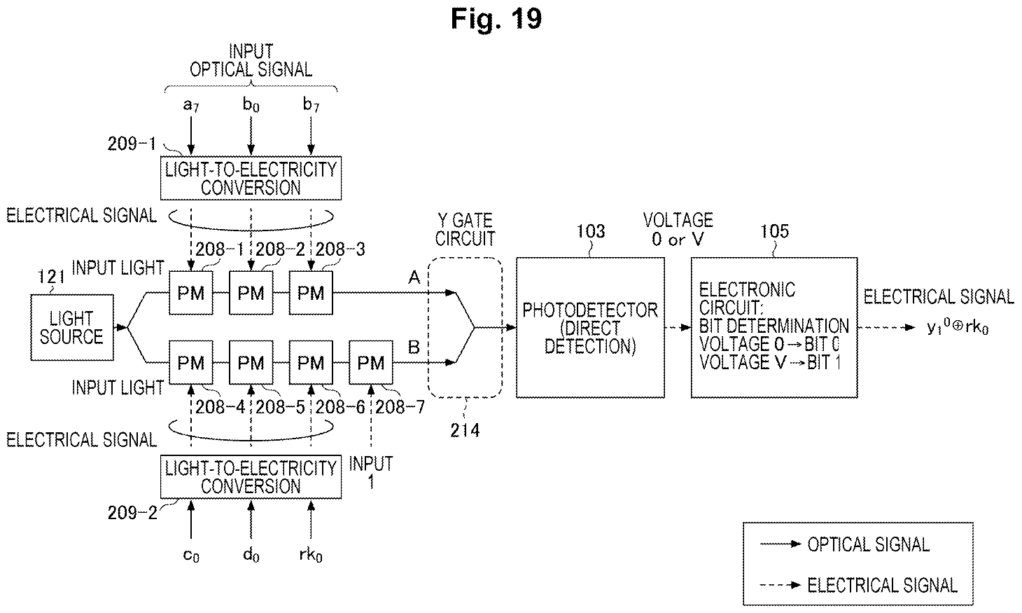

As a modification of the implementation example illustrated in FIG. 16, a 6-bit XOR operation may be implemented by the implementation example illustrated in FIG. 19. The implementation example illustrated in FIG. 19 is obtained by adding, to the implementation example illustrated in FIG. 16, a PM 208-7 that receives an electrical signal representing bit 1, and a Y gate circuit 214 that receives an optical signal A output from the PM 208-3 and an optical signal B output from the PM 208-7. The photodetection unit 131 of the photodetector 103 detects an optical signal output from the Y gate circuit 214 by direct detection, and the photoelectric conversion unit 132 outputs the voltage V if the intensity of the optical signal is equal to or greater than a certain threshold, and outputs the voltage 0 if the intensity is less than the threshold. The electronic circuit 105 determines that the bit is 0 if the voltage 0 has been input, and determines that the bit is 1 if the voltage V has been input, and then outputs an electrical signal representing the determination result. The value represented by this electrical signal is the result of the XOR operation of y₁⁰ and rk₀ (the result of the 6-bit XOR operation), and is stored in the memory 104.

In this implementation example, input light passing through the lower path is always shifted by a phase π at the PM 208-7. Thus, the intensity of input light obtained by superimposing input light A and input light B on each other at the Y gate circuit 214 corresponds to a result of a 6-bit XOR operation of a₇, b₀, b₇, c₀, d₀, and rk₀.

For example, in a case where (a₇, b₀, b₇, c₀, d₀, rk₀)=(1, 1, 1, 1, 1, 1) holds, the phase difference between the input light A and the input light B is π. Therefore, in a case where the input light A and the input light B have been superimposed on each other at the Y gate circuit 214, the intensity of the optical signal output from the Y gate circuit 214 becomes 0. Thus, the voltage 0 is output from the photodetector 103, and an electrical signal representing bit 0 is finally output from the electronic circuit 105.

As another example, for example, in a case where (a₇, b₀, b₇, c₀, d₀, rk₀)=(1, 0, 0, 1, 1, 0) holds, the phase difference between the input light A and the input light B becomes 0. Therefore, in a case where the input light A and the input light B have been superimposed on each other at the Y gate circuit 214, the intensity of the optical signal output from the Y gate circuit 214 is twice the intensity of the original input light. Thus, the voltage V is output from the photodetector 103, and an electrical signal representing bit 1 is finally output from the electronic circuit 105.

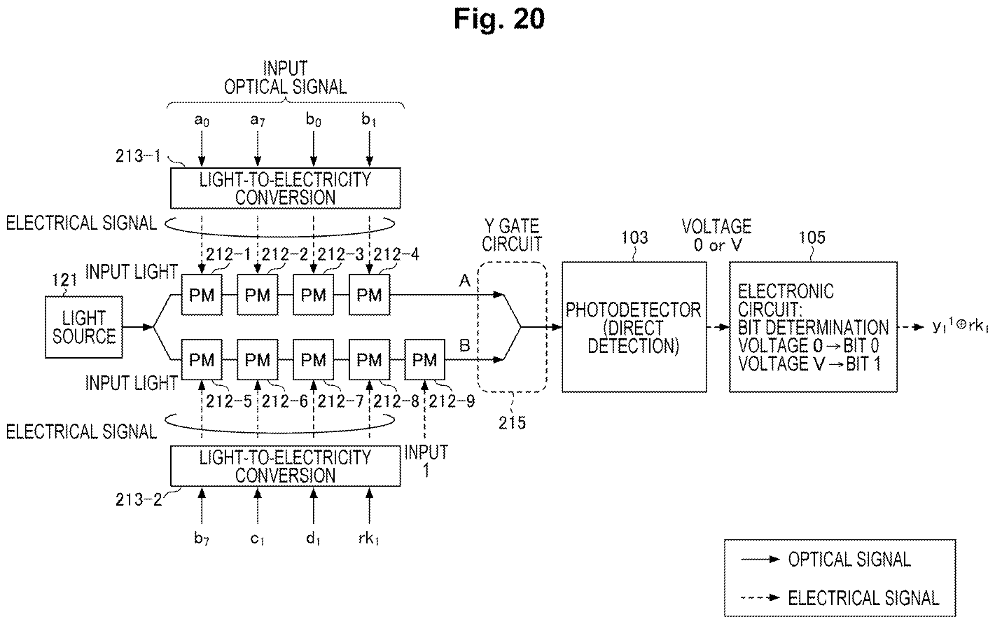

As a modification of the implementation example illustrated in FIG. 18, an 8-bit XOR operation may be implemented by the implementation example illustrated in FIG. 20. The implementation example illustrated in FIG. 20 is obtained by adding, to the implementation example illustrated in FIG. 18, a PM 212-9 that receives an electrical signal representing bit 1, and a Y gate circuit 215 that receives an optical signal A output from the PM 212-4 and an optical signal B output from the PM 212-9. As in the implementation example illustrated in FIG. 19, the photodetection unit 131 of the photodetector 103 detects an optical signal output from the Y gate circuit 214 by direct detection, and the photoelectric conversion unit 132 outputs the voltage V if the intensity of the optical signal is equal to or greater than a certain threshold, and outputs the voltage 0 if the intensity is less than the threshold. The electronic circuit 105 determines that the bit is 0 if the voltage 0 has been input, and determines that the bit is 1 if the voltage V has been input, and then outputs an electrical signal representing the determination result. The value represented by this electrical signal is the result of the XOR operation of y₁¹ and rk₁ (the result of the 8-bit XOR operation), and is stored in the memory 104.

As described above, it is possible to implement a 6-bit XOR operation and an 8-bit XOR operation also by the method using direct detection by the photodetector 103.

### Implementation Example (C): Implementation Method in which a Bit is Expressed by a Path of Light (Using an MZI Circuit)

A method of expressing bit 1 or bit 0 by using an MZI circuit will be described.

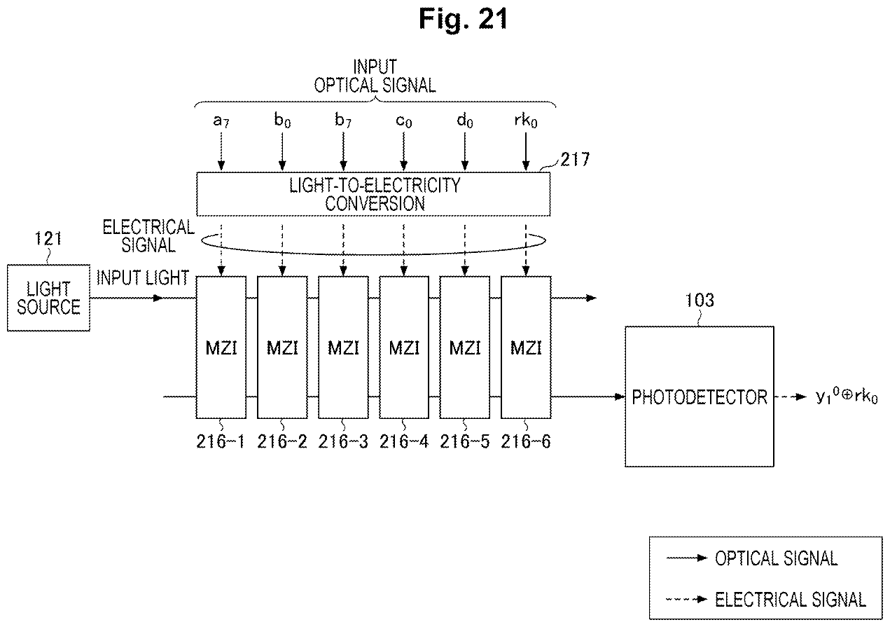

FIG. 21 illustrates an implementation example of the optical operation circuit 101 in a case where a 6-bit XOR operation is performed. As illustrated in FIG. 21, the optical operation circuit 101 is implemented such that six MZI circuits 216-1 to 216-6 are connected in series, and an optical signal from the light source 121 is input to the upper optical signal port of the MZI circuit 216-1. Since the path control ports of the MZI circuits 216-1 to 216-6 receive electrical signals, photoelectric conversion 217 for converting the optical signals a₇, b₀, b₇, c₀, d₀, and rk₀ into electrical signals is also implemented in the optical operation circuit 101. Furthermore, implementation is performed such that an optical signal output from the lower optical signal port of the MZI circuit 216-6 is input to the photodetector 103.

At this time, in a case where an even number (including 0) of a₇, b₀, b₇, c₀, d₀, and rk₀ is bit 1, an optical signal from the light source 121 is output from the upper optical signal port of the MZI circuit 216-6. On the other hand, in a case where an odd number of them is bit 1, an optical signal from the light source 121 is output from the lower optical signal port of the MZI circuit 216-6. Therefore, the photodetector 103 may output an electrical signal representing bit 1 from the photoelectric conversion unit 132 if the photodetection unit 131 has detected an optical signal, and may output an electrical signal representing bit 0 from the photoelectric conversion unit 132 if the photodetection unit 131 has not detected an optical signal. The value represented by this electrical signal is the result of the XOR operation of y₁⁰, and rk₀ (the result of the 6-bit XOR operation), and is stored in the memory 104.

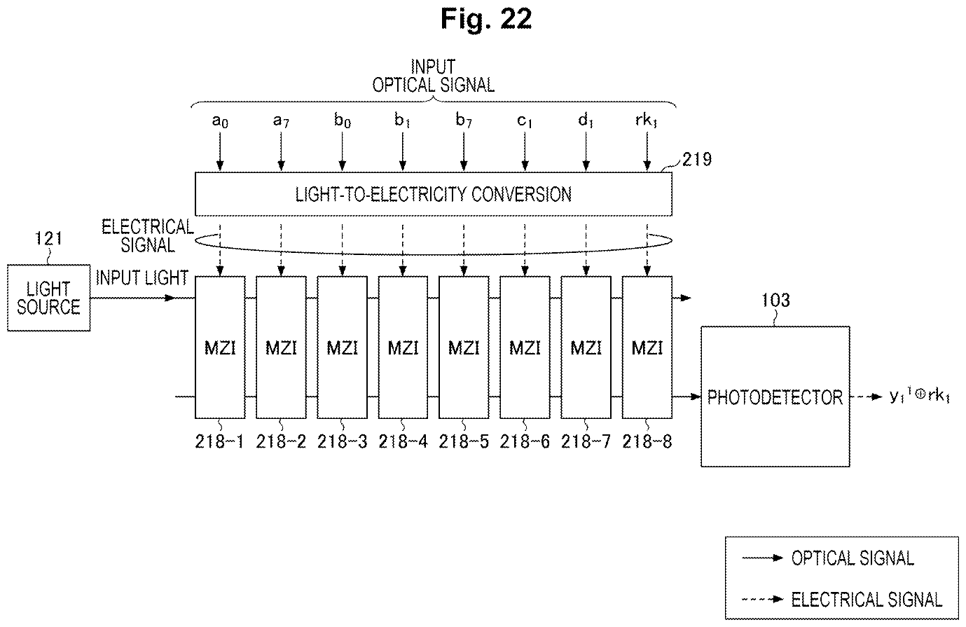

FIG. 22 illustrates an implementation example of the optical operation circuit 101 in a case where an 8-bit XOR operation is performed. As illustrated in FIG. 22, the optical operation circuit 101 is implemented such that eight MZI circuits 218-1 to 218-8 are connected in series, and an optical signal from the light source 121 is input to the upper optical signal port of the MZI circuit 218-1. Since the path control ports of the MZI circuits 218-1 to 218-8 receive electrical signals, photoelectric conversion 219 for converting the optical signals a₀, a₇, b₀, b₁, b₇, c₁, d₁, and rk₁ into electrical signals is also implemented in the optical operation circuit 101. Furthermore, implementation is performed such that an optical signal output from the lower optical signal port of the MZI circuit 218-8 is input to the photodetector 103.

At this time, as in the implementation example illustrated in FIG. 21, in a case where an even number (including 0) of a₀, a₇, b₀, b₁, b₇, c₁, d₁, and rk₁ is bit 1, an optical signal from the light source 121 is output from the upper optical signal port of the MZI circuit 218-8. On the other hand, in a case where an odd number of them is bit 1, an optical signal from the light source 121 is output from the lower optical signal port of the MZI circuit 218-8. Therefore, the photodetector 103 may output an electrical signal representing bit 1 from the photoelectric conversion unit 132 if the photodetection unit 131 has detected an optical signal, and may output an electrical signal representing bit 0 from the photoelectric conversion unit 132 if the photodetection unit 131 has not detected an optical signal. The value represented by this electrical signal is the result of the XOR operation of y₁¹ and rk₁ (the result of the 8-bit XOR operation), and is stored in the memory 104.

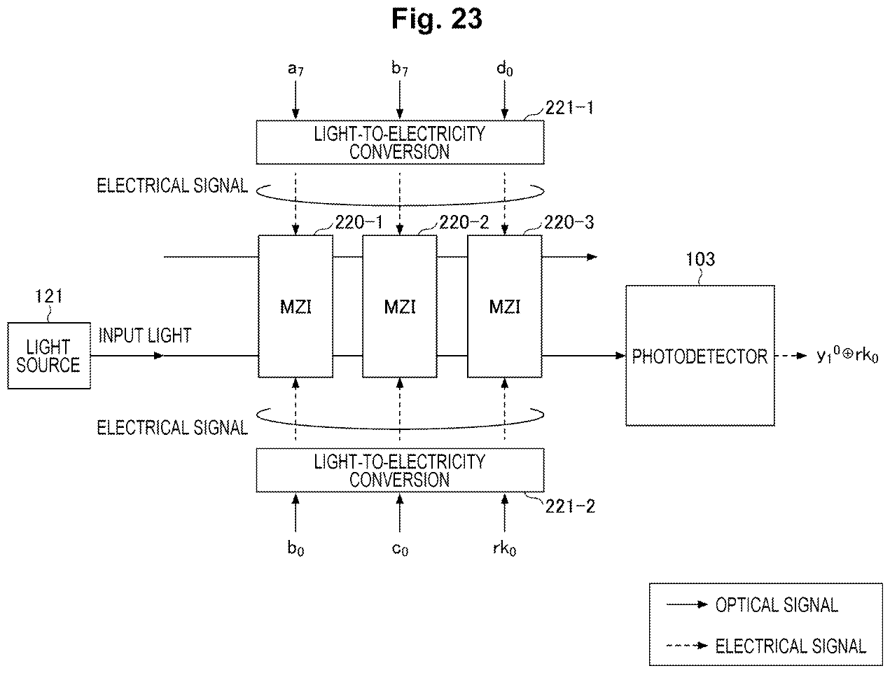

Furthermore, as an implementation example of the optical operation circuit 101 in a case where a 6-bit XOR operation is performed, an implementation example illustrated in FIG. 23 can be used. The implementation example illustrated in FIG. 23 is an implementation example of a case where a 6-bit XOR operation is implemented using 2-input port MZI circuits.

As illustrated in FIG. 23, the optical operation circuit 101 is implemented such that three 2-input port MZI circuits 220-1 to 220-3 are connected in series, and an optical signal from the light source 121 is input to the lower optical signal port of the 2-input port MZI circuit 220-1. Since the path control ports of the 2-input port MZI circuits 220-1 to 220-3 receive electrical signals, photoelectric conversion 221-1 for converting the optical signals a₇, b₇, and d₀ into electrical signals and photoelectric conversion 221-2 for converting the optical signals b₀, c₀, and rk₀ into electrical signals are implemented in the optical operation circuit 101. Furthermore, implementation is performed such that an optical signal output from the lower optical signal port of the 2-input port MZI circuit 220-3 is input to the photodetector 103.

At this time, in a case where an even number (including 0) of a₇, b₀, b₇, c₀, d₀, and rk₀ is bit 1, an optical signal from the light source 121 is output from the upper optical signal port of the 2-input port MZI circuit 220-3. On the other hand, in a case where an odd number of them is bit 1, an optical signal from the light source 121 is output from the lower optical signal port of the 2-input port MZI circuit 220-3. Therefore, as in the implementation example illustrated in FIG. 21, an XOR operation of y₁⁰ and rk₀ (6-bit XOR operation) is implemented. This implementation example allows for a reduction in the number of MZI circuits as compared with the implementation example illustrated in FIG. 21, and therefore has an advantage that a decrease in calculation delay and a decrease in circuit area are achieved.

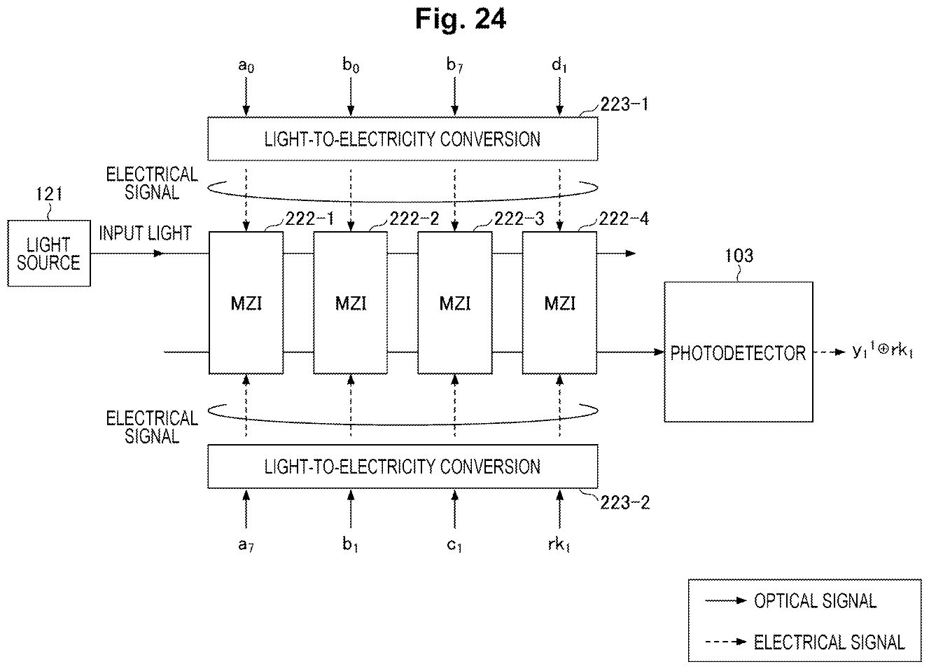

Similarly, as an implementation example of the optical operation circuit 101 in a case where an 8-bit XOR operation is performed, an implementation example illustrated in FIG. 24 can be used. The implementation example illustrated in FIG. 24 is an implementation example of a case where an 8-bit XOR operation is implemented using 2-input port MZI circuits.

As illustrated in FIG. 24, the optical operation circuit 101 is implemented such that four 2-input port MZI circuits 222-1 to 222-4 are connected in series, and an optical signal from the light source 121 is input to the upper optical signal port of the 2-input port MZI circuit 222-1. Since the path control ports of the 2-input port MZI circuits 222-1 to 222-4 receive electrical signals, photoelectric conversion 223-1 for converting the optical signals a₀, b₀, b₇, and d₁ into electrical signals and photoelectric conversion 223-2 for converting the optical signals a₇, b₁, c₁, and rk₁ into electrical signals are implemented in the optical operation circuit 101.

Furthermore, implementation is performed such that an optical signal output from the lower optical signal port of the 2-input port MZI circuit 222-4 is input to the photodetector 103.

At this time, as in the implementation example illustrated in FIG. 22, in a case where an even number of a₀, a₇, b₀, b₁, b₇, c₁, d₁, and rk₁ is bit 1, an optical signal from the light source 121 is output from the upper optical signal port of the 2-input port MZI circuit 222-4. On the other hand, in a case where an odd number of them is bit 1, an optical signal from the light source 121 is output from the lower optical signal port of the 2-input port MZI circuit 222-4. Therefore, the photodetector 103 may output an electrical signal representing bit 1 from the photoelectric conversion unit 132 if the photodetection unit 131 has detected an optical signal, and may output an electrical signal representing bit 0 from the photoelectric conversion unit 132 if the photodetection unit 131 has not detected an optical signal. The value represented by this electrical signal is the result of the XOR operation of y₁¹ and rk₁ (the result of the 8-bit XOR operation), and is stored in the memory 104. This implementation also allows for a reduction in the number of MZI circuits as compared with the implementation example illustrated in FIG. 22, and therefore has an advantage that a decrease in calculation delay and a decrease in circuit area are achieved.

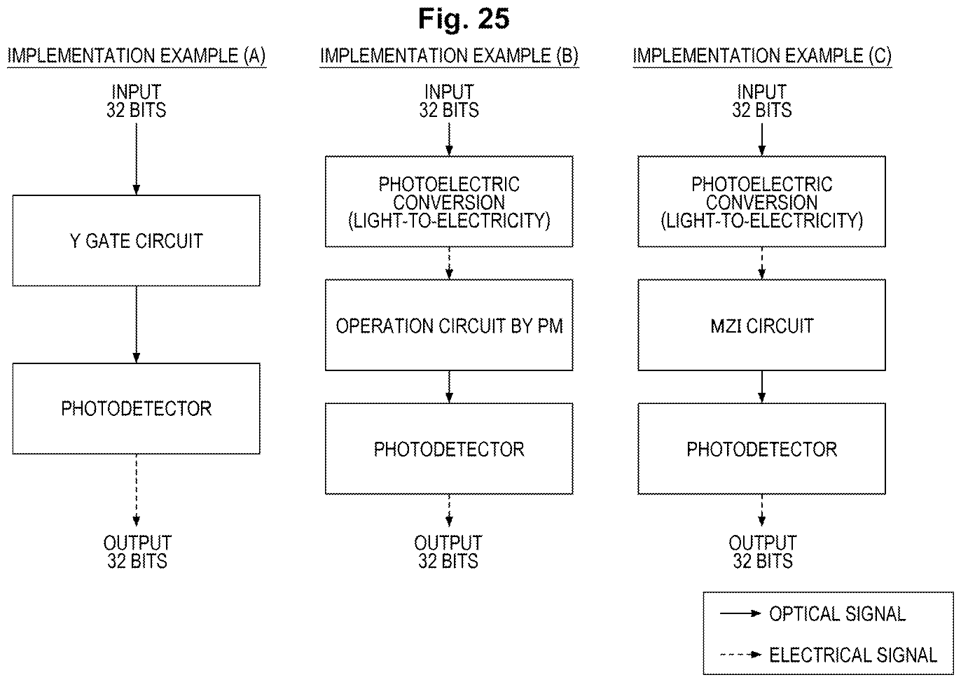

FIG. 25 collectively illustrates the above implementation examples (A), (B), and (C). As illustrated in FIG. 25, the implementation example (A) uses a Y gate circuit, the implementation example (B) uses a PM, and the implementation example (C) uses an MZI circuit, in which optical signals are received in all of them, but photoelectric conversion is unnecessary in the implementation example (A).

### <<Implementation Example of Entire Data Operation Unit>>

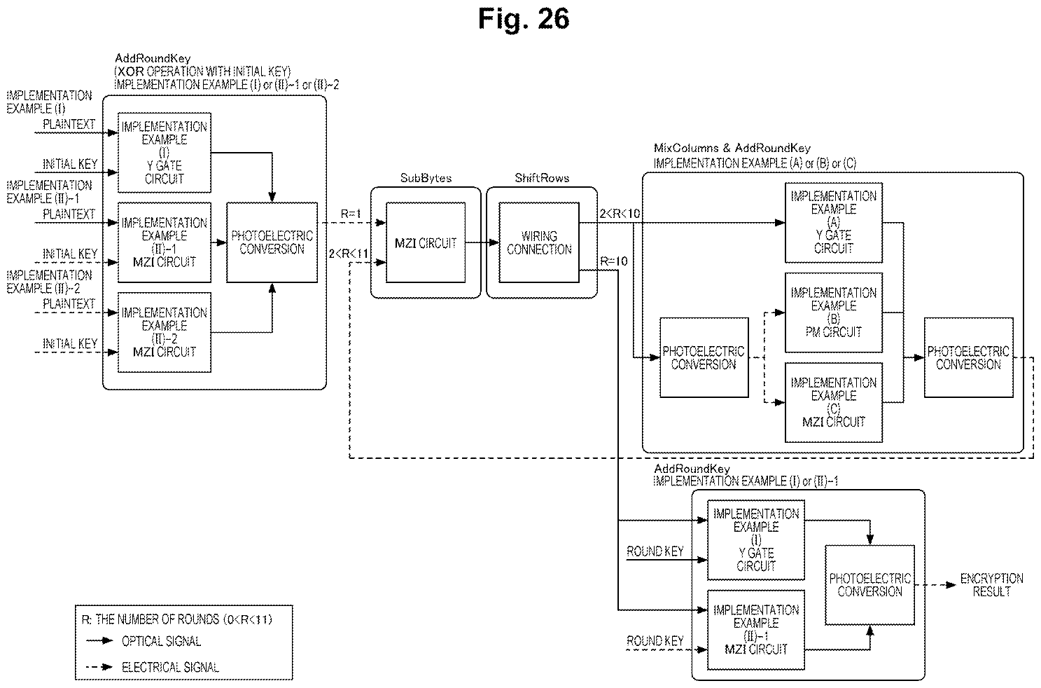

In the implementation examples described above, optical operation processing is used to implement one round of the data operation unit of the AES. FIG. 26 illustrates an implementation example of the entire data operation unit of the AES. At this time, changing of timing of calculation by the data operation unit (that is, determination of timing to start next round processing) is managed by clocks, and the length of one clock is set to a time sufficiently longer than the optical path calculation time for all 128 bits. In the drawing, R represents the number of rounds.

As illustrated in FIG. 26, AddRoundKey (XOR operation with an initial key) at the time of R=1 is implemented in any of the implementation examples (I), (II)-1, and (II)-2. In the implementation example (I), a plaintext and an initial key are input in the form of optical signals, and an XOR operation with the initial key is performed. In the implementation example (II)-1, a plaintext is input in the form of an optical signal and an initial key is input in the form of an electrical signal, and then an XOR operation with the initial key is performed. In the implementation example (II)-2, a plaintext and an initial key are input in the form of electrical signals, and an XOR operation with the initial key is performed. SubBytes is implemented by an MZI circuit (an optical pass gate logic circuit in which MZI circuits are connected in multiple stages), and ShiftRows is implemented by a wiring connection (by changing the connection of the wiring). MixColumns and AddRoundKey with a round key are implemented in any of the implementation examples (A), (B), and (C).

SubBytes and ShiftRows are repeated 10 times for R=1 to 10. On the other hand, MixColumns and AddRoundKey with a round key are repeated nine times for R=1 to 9. MixColumns is not calculated at the time of R=10 (final round), and thus AddRoundKey at the time of R=10 is implemented in either of the implementation examples (I) and (II)-1. As a result, an XOR operation of the round key and intermediate data for the final round is conducted. Implementation in either of the implementation examples (I) and (II)-1 may depend on whether the round key is retained in the light state or retained electrically. Then, a result of calculation by AddRoundKey at the time of R=10 is used as an encryption result (electrical signal).

### <Key Schedule Unit>

Hereinafter, a method of implementing calculation by the key schedule unit using optical operation processing in a case where the secret key is 128-bits long will be described. Also in a case where the secret key is 192-bits long or 256-bits long, implementation is possible by a similar method.

The key schedule unit divides the secret key (128 bits) into four blocks, 32 bits each, and conducts calculation. This operation processing includes an XOR operation between RotWord, SubWord, and Rcon, and an intermediate value (Reference Literature 1). At this time, it does not matter whether the secret key (initial key) is electrically retained or retained in the light state.

A method for determining a bit value depending on the amplitude of light will be described below.
RotWord

In this processing, four blocks of 32 bits are divided into 8 bits, and 8-bit left rotation is performed. Thus, as in ShiftRows, in a case where the secret key or the round key of the previous stage is retained in the light state, this processing is implemented by changing the connection of the wiring (optical signal line). In a case where the secret key or the round key of the previous stage is electrically retained, implementation is achieved by changing the connection of the electric wiring.
SubWord

In this processing, SubBytes used when each block is encrypted every 8 bits is applied. Thus, it is possible to use a SubBytes optical pass gate logic circuit using an MZI circuit. In a case where the initial key is electrically retained and RotWord outputs an electrical signal, the electrical signal is input to SubBytes as it is. On the other hand, in a case where the initial key is retained in the light state and RotWord outputs an optical signal, the optical signal needs to be converted into an electrical signal by photoelectric conversion and then input to SubBytes.
XOR operation of Rcon and intermediate value

The j-th (0<j<12) Rcon is denoted by Rconⱼ. Each Rconⱼ is a 32-bit fixed value having 4 blocks of 8 bits each. Here, in the initial round of the key schedule, SubWord outputs w₃′. Note that w₃′ is 32 bits.

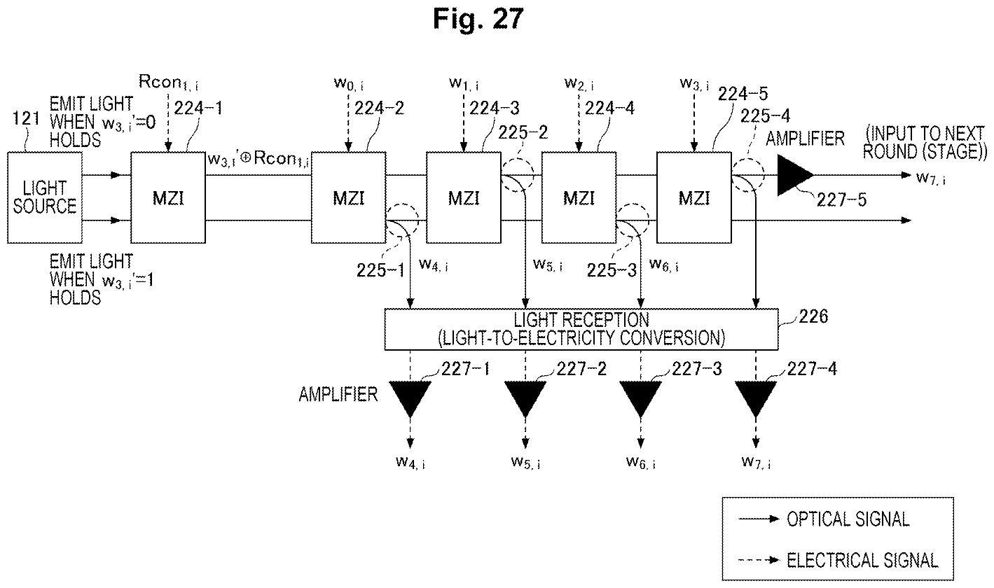

FIG. 27 illustrates an implementation example for implementing a 1-bit XOR operation in this initial round. Note that i (0≤i≤31) represents a bit position, and for example, w_{3,i}′ represents a bit value of the bit position i of w₃′, and Rcon_{1,i} represents a bit value of the bit position i of Rconᵢ. The same applies to w_{4,i}, w_{5,i}, and the like.

As illustrated in FIG. 27, the optical operation circuit 101 is implemented by MZI circuits 224-1 to 224-5 connected in series, directional couplers 225-1 to 225-4, photoelectric conversion 226, and amplifiers 227-1 to 227-5. At this time, the light source 121 is caused to emit light such that an optical signal is input to the upper optical signal port of the MZI circuit 224-1 if w_{3,i}′=0 holds, and an optical signal is input to the lower optical signal port of the MZI circuit 224-1 if w_{3,i}′=1 holds. If =0 holds, no optical signal is input to the lower optical signal port of the MZI circuit 224-1, and if w_{3,i}′=1 holds, no optical signal is input to the upper optical signal port of the MZI circuit 224-1.

The path control ports of the MZI circuits 224-1 to 224-5 receive Rcon_{1,i}, w_{0,1}, w_{1,i}, w_{2,i}, and w_{3,i}, respectively.

The directional coupler 225-1 divides an optical signal output from the lower optical signal port of the MZI circuit 224-2, and outputs one of the divided optical signals to the photoelectric conversion 226. Similarly, the directional coupler 225-2 divides an optical signal output from the upper optical signal port of the MZI circuit 224-3, the directional coupler 225-3 divides an optical signal output from the lower optical signal port of the MZI circuit 224-4, and the directional coupler 225-4 divides an optical signal output from the upper optical signal port of the MZI circuit 224-5, and then each directional coupler outputs one of the divided optical signals to the photoelectric conversion 226. That is, the directional couplers are arranged alternately, such as the lower optical signal port, the upper optical signal port, and the lower optical signal port. A division ratio at which an optical signal is divided may be arbitrarily set.

The amplifiers 227-1 to 227-4 amplify the amplitude to obtain an electrical signal capable of controlling the path of an MZI circuit in the next round. Furthermore, since the amplitude is attenuated by the division of the optical signal, the amplitude is amplified by the amplifier 227-5. However, the amplifiers 227-1 to 227-5 are not essential, and all or some of the amplifiers 227-1 to 227-5 may be omitted in a case where the decrease in amplitude is negligible.

At this time, an output from the upper optical signal port of the MZI circuit 224-1 corresponds to an XOR operation of w_{3,i}′ and Rcon_{1,i}. Electrical signals w_{4,i}, w_{5,i}, w_{6,i}, and w_{7,i} that have been output from the photoelectric conversion 226 and have passed through the amplifiers 227-1 to 227-4 are input to the path control port of an MZI circuit in the next round. On the other hand, the optical signal w_{7,i} that has passed through the amplifier 227-5 is used as an input in the next round, and whether an optical signal from the light source 121 in the next round is to be input to the upper optical signal port or the lower optical signal port of the first of the MZI circuits connected in series is controlled depending on whether the value of the optical signal w_{7,i} is 0 or 1.

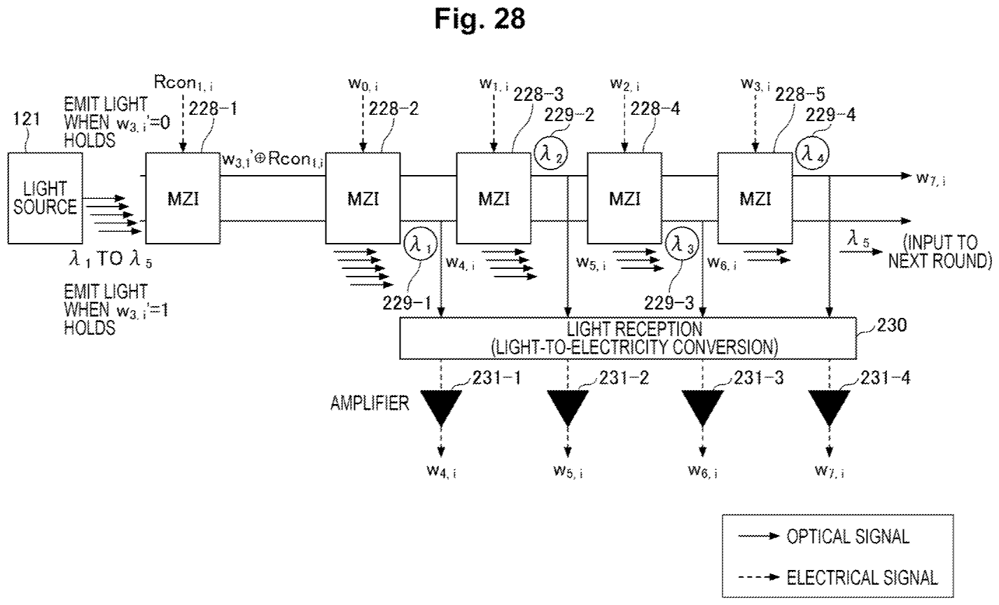

It is also possible to adopt an implementation in which input light having five wavelengths (λ₁, λ₂, λ₃, λ₄, and λ₅) is used as an optical signal output from the light source 121. FIG. 28 illustrates this implementation example. As illustrated in FIG. 28, the optical operation circuit 101 is implemented by MZI circuits 228-1 to 228-5 connected in series, filters 229-1 to 229-4, photoelectric conversion 230, and amplifiers 231-1 to 231-4. At this time, the light source 121 is caused to emit light such that an optical signal is input to the upper optical signal port of the MZI circuit 228-1 if w_{3,i}′=0 holds, and an optical signal is input to the lower optical signal port of the MZI circuit 228-1 if w_{3,i}′=1 holds. If w_{3,i}′=0 holds, no optical signal is input to the lower optical signal port of the MZI circuit 228-1, and if w_{3,i}′=1 holds, no optical signal is input to the upper optical signal port of the MZI circuit 228-1.

The path control ports of the MZI circuits 228-1 to 228-5 receive Rcon_{1,i}, w_{0,i}, w_{1,i}, w_{2,i}, and w_{3,i}, respectively.

The filter 229-1 is a filter using a ring resonator having the wavelength λ₁ or the like, and extracts only optical signals having the wavelength λ₁ from optical signals output from the lower optical signal port of the MZI circuit 228-2 and outputs the extracted optical signals to the photoelectric conversion 230. Similarly, the filter 229-2 is a filter using a ring resonator having the wavelength λ₂ or the like, and extracts only optical signals having the wavelength λ₂ from optical signals output from the upper optical signal port of the MZI circuit 228-3 and outputs the extracted optical signals to the photoelectric conversion 230. The same applies to the filters 229-3 and 229-4, in which the filter 229-3 extracts only optical signals having the wavelength λ₃ from optical signals output from the lower optical signal port of the MZI circuit 228-4, and the filter 229-4 extracts only optical signals having the wavelength λ₄ from optical signals output from the upper optical signal port of the MZI circuit 228-5, and then each filter outputs the extracted optical signals to the photoelectric conversion 230. The filters are arranged alternately, such as the lower optical signal port, the upper optical signal port, and the lower optical signal port.

The amplifiers 231-1 to 231-4 amplify the amplitude to obtain an electrical signal capable of controlling the path of an MZI circuit in the next round. However, the amplifiers 231-1 to 231-5 are not essential, and all or some of the amplifiers 231-1 to 231-5 may be omitted in a case where the decrease in amplitude is negligible. Optical signals are not divided in the implementation example illustrated in FIG. 28, and this almost eliminates attenuation of the optical signals, and eliminates the need for an amplifier for amplifying the amplitude of an optical signal.

At this time, an output from the upper optical signal port of the MZI circuit 228-1 corresponds to an XOR operation of w_{3,i}′ and Rcon_{1,i}. The electrical signals w_{4,i}, w_{5,i}, w_{6,i}, and w_{7,i} that have been output from the photoelectric conversion 230 and have passed through the amplifiers 231-1 to 231-4 are input to the path control port of an MZI circuit in the next round. On the other hand, the finally output optical signal w_{7,i} is used as an input in the next round, and whether an optical signal from the light source 121 in the next round is to be input to the upper optical signal port or the lower optical signal port of the first of the MZI circuits connected in series is controlled depending on whether the value of the optical signal w_{7,i} is 0 or 1.

By repeatedly executing the calculation by the implementation example illustrated in FIG. 27 or 28 described above for i=0, . . . , 31, calculation of (w₄, w₅, w₅, w₇) for 128 bits is performed. Alternatively, the implementation example illustrated in FIG. 27 or 28 described above may be implemented in parallel, and calculation of (w₄, w₅, w₆, w₇) for 128 bits may be performed by repeating the calculation less than 32 times. Calculation of (w₈, w₉, w₁₀, w₁₁) is performed in the next round, and calculation of (w₁₂, w₁₃, w₁₄, w₁₅) is performed in the round after the next round. The same applies to the following rounds.

Calculation in the key schedule unit can be performed by repeating an XOR operation between RotWord, SubWord, and Rcon, and an intermediate value for 10 rounds.

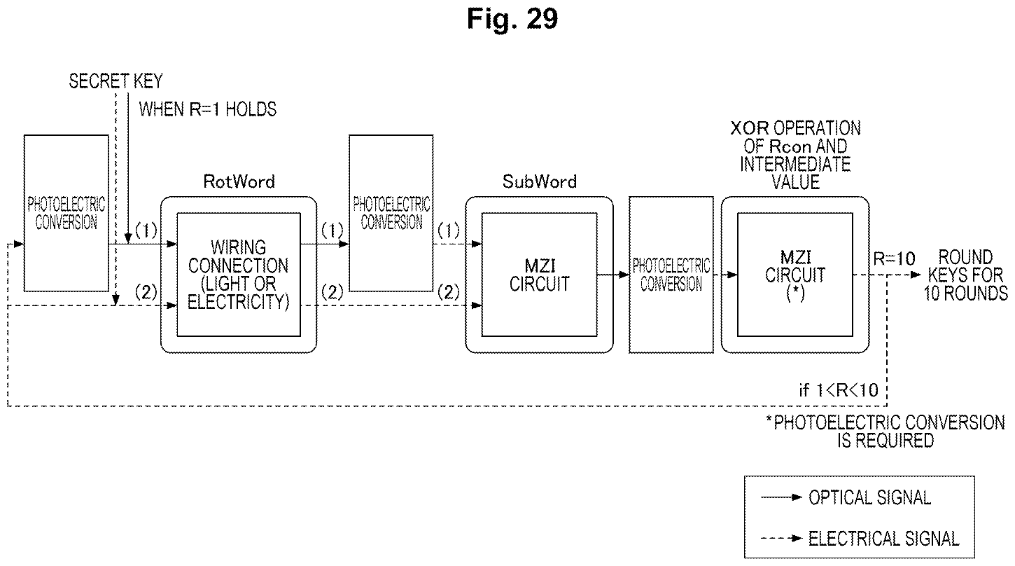

In the implementation examples described above, optical operation processing is used to implement one round of the key schedule unit of the AES. FIG. 29 illustrates an implementation example of the entire key schedule unit of the AES. As illustrated in FIG. 29, when a round key is generated, either (1) or (2) is executed. (1) is a case where the secret key or the round key in the previous round is retained in the light state, and photoelectric conversion from an optical signal into an electrical signal is required between RotWord and SubWord. On the other hand, (2) is a case where the secret key or the round key in the previous round is electrically retained.

### CONCLUSION

As described above, the optical operation circuit 101 of the encryption device 10 according to the present embodiment is implemented by a Y gate circuit, an optical switching circuit, or the like, and can use optical operation processing to implement an XOR operation, a multistage XOR operation, and a nonlinear operation (implement, in particular, a multistage XOR operation and a nonlinear operation that have been conventionally difficult to perform). Therefore, the optical encryption operation unit 111 and the optical operation control unit 112 of the encryption device 10 according to the present embodiment can use optical operation processing to implement an encryption operation (e.g., encryption/decryption processing or authentication/verification processing) used in various encryption methods and authentication methods. While the above embodiment describes a case of using optical operation processing to implement an AES encryption operation by using optical operation processing to implement an XOR operation, a multistage XOR operation, and a nonlinear operation, it is needless to say that the encryption device 10 according to the present embodiment can use optical operation processing to implement an XOR operation, a multistage XOR operation, and a nonlinear operation of encryption operations in other encryption methods and authentication methods.

The present invention is not limited to the embodiment specifically disclosed above, and various modifications or changes, combinations with known technologies, and the like can be made without departing from the scope of the claims.

### REFERENCE LITERATURES

Reference Literature 1: Federal Information Processing Standards Publication 197 Nov. 26, 2001 Announcing the ADVANCED ENCRYPTION STANDARD (AES)
Reference Literature 2: Shota Kita, Kengo Nozaki, Kenta Takata, Akihiko Shinya, Masaya Notomi, Ultrashort low-loss ψ gates for linear optical logic on Si photonics platform, Communications Physics, volume 3, Article number: 33 (2020), 8 pages.
Reference Literature 3: Japanese Unexamined Patent Application Publication No. 2018-5825

### REFERENCE SIGNS LIST

10 Encryption device
101 Optical operation circuit
102 Optical transmitter
103 Photodetector
104 Memory
111 Optical encryption operation unit
112 Optical operation control unit
121 Laser transmission unit
122 Light source control unit
131 Photodetection unit
132 Photoelectric conversion unit

1. A cypher system comprising:
a plurality of hardware computers, each hardware computer including a photoelectric fusion processor that includes at least one of (i) a Y gate circuit configured to combine optical signals, (ii) an optical switching circuit configured to switch optical signal paths based on electrical signals, or (iii) a phase modulator configured to modulate a phase of an optical signal,
wherein the photoelectric fusion processor is configured to perform optical operation processing and perform an encryption operation including
an exclusive OR operation in which two or more bit values are given as inputs, and
a nonlinear operation in which two or more bit values are given as inputs.

2. The cypher system according to claim 1, wherein
the photoelectric fusion processor includes a multistage circuit of Y gates, and
the optical operation processing includes
inputting optical signals individually corresponding to the two or more bit values to the multistage circuit,
detecting intensity of an optical signal output from the multistage circuit, and
outputting a bit value corresponding to the intensity as a result of the exclusive OR operation.

3. The cypher system according to claim 1, wherein
the photoelectric fusion processor includes a plurality of phase modulators, each phase modulator configured to modulate the phase of the optical signal by π in accordance with a given bit value, and
the optical operation processing includes
inputting, to the plurality of phase modulators, respective electrical signals individually corresponding to the two or more bit values and an optical signal,
detecting a phase difference that is derived from chases of respective optical signals output from the plurality of phase modulators, and
outputting a bit value corresponding to the phase difference as a result of the exclusive OR operation.

4. The cypher system according to claim 1, wherein
the photoelectric fusion processor includes a plurality of optical switching circuits connected in series, each optical switching circuit including a predetermined output port, and
the optical operation processing includes
inputting, to the plurality of optical switching circuits, respective electrical signals individually corresponding to the two or more bit values and an optical signal,
detecting an optical signal output from the predetermined output port of a last optical switching circuit of the plurality of optical switching circuits, and
outputting a bit value corresponding to intensity of the optical signal as a result of the exclusive OR operation.

5. The cypher system according to claim 1, wherein
the photoelectric fusion processor includes a multistage optical switching circuit with a predetermined output port, and
the optical operation processing includes
inputting, to the multistage optical switching circuit, (i) electrical signals individually corresponding to the two or more bit values and (ii) optical signals individually representing bit values that are included in a bit string, the bit string being defined by applying a predetermined transformation, and
outputting a bit value corresponding to an optical signal output from the predetermined output port of the multistage optical switching circuit, as a result of the nonlinear operation for a predetermined bit value of the two or more bit values.

6. A cypher apparatus comprising:
a photoelectric fusion processor including at least one of (i) a Y gate circuit configured to combine optical signals, (ii) an optical switching circuit configured to switch optical signal paths based on electrical signals, or (iii) a phase modulator configured to modulate a phase of an optical signal,
wherein the photoelectric fusion processor is configured to perform optical operation processing and perform an encryption operation including
an exclusive OR operation in which two or more bit values are given as inputs, and
a nonlinear operation in which two or more bit values are given as inputs.

7. A cypher method by a photoelectric fusion processor including at least one of (i) a Y gate circuit configured to combine optical signals, (ii) an optical switching circuit configured to switch optical signal paths based on electrical signals, or (iii) a phase modulator configured to modulate a phase of an optical signal, the cypher method comprising:
preforming optical operation processing and an encryption operation including
an exclusive OR operation in which two or more bit values are even as inputs, and
a nonlinear operation in which two or more bit values are given as inputs.

8. A non-transitory computer readable medium storing a program causing a computer to execute the cypher method of claim 7.
